(19) United States
(12) Patent Application Publication
(10) Pub. No.: US 2025/0094693 A1
(43) Pub. Date: Mar. 20, 2025

(54) SYSTEM AND METHOD FOR CREATING COMPLEX DOCUMENTS USING GENERATIVE ARTIFICIAL INTELLIGENCE

(71) Applicant: Augment Legal, Inc., Arlington, VA (US)

(72) Inventor: Rix Ryskamp, Arlington, VA (US)

(73) Assignee: Augment Legal, Inc., Arlington, VA (US)

(21) Appl. No.: 18/959,175

(22) Filed: Nov. 25, 2024

Related U.S. Application Data
(63) Continuation-in-part of application No. 18/678,807, filed on May 30, 2024.
(60) Provisional application No. 63/577,872, filed on May 30, 2023.

(51) Int. Cl. G06F 40/166; G06F 16/332

(52) U.S. Cl. CPC G06F 40/166; G06F 16/332

(57) ABSTRACT

A method includes receiving a request to generate a first document; defining a plurality of segments for the first document based, at least in part, on the specification data; determining one or more relationships between one or more of the plurality of segments based, at least in part, on the specification data, determining one or more attributes for each of the plurality of segments based, at least in part, on the specification data; generating at least a portion of a prompt for each segment based, at least in part, on at least one of the one or more relationships and the one or more attributes; submitting the at least a portion of the prompt for each segment to at least one generative AI; receiving respective results from the at least one generative AI for each segment; and combining the respective results to generate the first document.

### CROSS-REFERENCE TO RELATED APPLICATIONS

This application is a continuation-in-part of U.S. application Ser. No. 18/678,807, filed May 30, 2024, for SYSTEM AND METHOD FOR IMPROVING RESULTS FROM ARTIFICIAL INTELLIGENCE, which claims the benefit of U.S. Provisional Application No. 63/577,872, filed May 30, 2023, for SYSTEM AND METHOD FOR IMPROVING RESULTS FROM ARTIFICIAL INTELLIGENCE and U.S. Provisional Application No. 63/629,567, filed Nov. 6, 2023, for A SYSTEM AND METHOD FOR GENERATING ACCURATE LEGAL DOCUMENTS. Each of the foregoing applications is fully incorporated herein by reference.

### TECHNICAL FIELD

The present disclosure relates to generative artificial intelligence (AI). More specifically, the present disclosure relates to systems and methods for improving the results of generative AI including the preparation of complex documents, such as legal documents.

### BACKGROUND

Generative AI can be used to create text, images, video, audio, 3D models, computer programs, computer code, binary data, structured data, and other many other types of data. It can also be used to edit or modify existing versions of such data. Current generative AI Systems (also referred to herein as “generative AIs”) include OpenAI GPT, Google Gemini, Meta LLaMA, Lex, Dall-E 2, Midjourney, Stable Diffusion, Amper, Dadabots, MuseNet, CodeStarter, Codex, GitHub Copilot, Tabnine, Descript, Listnr, Podcast.ai, and many other AI systems and models.

The foregoing systems are typically trained to create the same or similar content responses for every user that provides a given request. These inherently similar responses reduce the usefulness of generative AI in cases where users desire to produce content that is original. Generic content is also less helpful because it is less meaningful than content that is targeted at the specific tastes, needs, and desires of a particular user. This problem may be referred to hereafter as the “generic response problem.”

One method for solving the generic response problem is for users of generative AI to create long and detailed requests with many keywords that specify their individual needs to create unique, specific, and individualized content. In other words, their responses from the AI System become unique because the user works to develop a prompt to the AI System that is unique.

As an example, for a generative AI System that accepts text prompts as requests for generated content, two users that both provide a prompt to the generative AI System that states “write an essay on the city of Dumaguete, Philippines” may receive similar or even identical results. However, a user may have specific preferences about the style, format, or other attributes of the essay and may accordingly change their prompt that includes some of those preferences, such as
write an essay on the city of Dumaguete, Philippines;
always use the Oxford comma;
focus on the local people;
use a bulleted list;
do not exceed 800 words;
include an introductory and a conclusion paragraph; and
do not discuss politics.

Making a more detailed prompt ensures that the resulting generated output is more specific to the user's needs, but it also adds the burden of providing very detailed prompts, and such detail may reduce the benefits (e.g., time savings, ease-of-use, etc.) of using the AI to generate the essay in the first place. This problem is not unique to text-focused generative AI Systems. The generic response problem exists for both creating and modifying media including, but not limited to text, audio, images, video, 3D models, structured data, computer code, computer programs, binary data, structured data, and other media.

Recently, advances in generative AI technologies have allowed users of generative AI technologies to create complex documents, such as, but not limited to, legal documents or program code. Legal documents can be created by sending prompts to a generative AI System, which can be effective at generating rough drafts of legal documents. However, conventional systems are typically limited in their ability to create legal documents that are precise and accurate enough that they can be filed with a court or otherwise used in the legal profession.

Currently, in order generate accurate legal documents through generative AI, users may need to (a) create very detailed prompts for the generative AI, or (b) thoroughly edit the resulting documents, or both. The problem with using detailed prompts is that creating a prompt that is detailed enough to produce an accurate document takes significant time and effort. As effort required to create detailed directions to the generative AI increases, the time saved-as well as other benefits gained-by using a generative AI to create legal documents diminishes. Additionally, the knowledge and skill required to create these detailed prompts can limit their use to people with the skills and training required to create such prompts. For example, a user writing a motion to dismiss a complaint using a generative AI System may start with a simple prompt like “write a motion to dismiss this complaint: [complaint language here].” But the user may also want the system to use a cite a specific case for the motion under the 12(b)(6) legal standard, so the language prompt is modified to say, “write a motion to dismiss this complaint: [complaint language here], cite Sheppard v. Visitors of Va. State Univ., 993 F.3d 230, 234 (4th Cir. 2021) as the 12(b)(6) motion to dismiss standard.” In addition, the user may want to make sure that, in accordance with the court's formatting specifications, the header for each section is all caps and uses roman numerals, so the language prompt is modified to say, “write a motion to dismiss this complaint: [complaint language here], cite Sheppard v. Visitors of Va. State Univ., 993 F.3d 230, 234 (4th Cir. 2021) as the 12(b)(6) motion to dismiss standard, use all caps section headers with roman numerals.” The user has now generated a longer prompt that is still only specific as to a legal standard and one formatting direction and has not yet specified the myriad details still required to create a decent first draft of the motion. Listing every requirement in the prompt can be tedious. As the user continues to include specific details, the time spent writing the prompt diminishes the time savings and other benefits gained by using the generative AI in the first place.

Once the user has finished writing this prompt and received the responsive draft of the legal document, the user must still edit the document in order to produce a final version. Less specific prompts are likely to lead to more editing time because the produced document does not accurately reflect the user's final preferences. The user may also wish to use the generative AI as part of the editing process, and to do so may have to (a) modify the prompt again and regenerate, (b) give the document to the AI with new instructions (e.g., “please add oxford commas to this document: [document text here]”), or split the document up and change only certain sections at a time (e.g., “change this paragraph to be more deferential [paragraph text here]”). Each time the user asks the generative AI System to rebuild the document, the entire document must be re-reviewed, which can be time consuming. Additionally, if the user chooses to manage the document in individual sections (e.g., by copying and pasting sections back and forth between the document and the AI), the user is undertaking a burdensome task and introducing the risk of transposition error (e.g., as portions of the document are copied and pasted).

Another problem with using generative AI Systems to create legal documents is that lawyers and other legal professionals do not always want their documents to be overly generic or “boilerplate.” But the content created by generative AI Systems is often overly generic because such generative AI Systems, such as large language models (LLMs), are often trained by learning from large amounts of example work product. These systems sometimes learn what is “best” by learning with is most common in that work product. This method of training causes the systems to generate very common language, solutions, and arguments in generated text. One way to overcome such generic results is to create very specific prompts for the generative AI System. However, such a solution leads to the problems associated with creating very long prompts that is described above.

Another problem with creating complex legal documents through a generative AI is predictability. When generative AI Systems produce very large and complex documents, they rarely produce the same document word-for-word each time. Generative AI Systems will generally produce small variations in the document each time it is generated. A user may want to rely on these systems to consistently create the desired language for a complex legal document, but no conventional AI Systems exist to achieve this goal.

### SUMMARY

According to one aspect, a method for automatically generating a first document using generative artificial intelligence (AI) includes receiving a request to generate the first document, where the request includes specification data for the first document. The method also includes defining a plurality of segments for the first document based, at least in part, on the specification data. The method further includes determining one or more relationships between one or more of the plurality of segments based, at least in part, on the specification data. In addition, the method includes determining one or more attributes for each of the plurality of segments based, at least in part, on the specification data. The method also includes generating at least a portion of a prompt for each segment based, at least in part, on at least one of the one or more relationships and the one or more attributes, and submitting the at least a portion of the prompt for each segment to at least one generative AI. Further, the method includes receiving respective results from the at least one generative AI for each segment and combining, when necessary, the respective results to generate the first document.

In some configurations, the method further includes allowing a user to modify at least one of the one or more relationships and the one or more attributes prior to automatically generating the at least a portion of the prompt. In certain configurations, allowing the user to modify at least one of the one or more relationships or the one or more attributes includes displaying at least a portion of the plurality of segments, the one or more relationships, and the one or more attributes in a tree structure.

In various configurations, the method includes displaying the respective results and allowing a user to edit the respective results for at least one segment before combining the respective results to generate the first document if multiple portions of a prompt were generated.

In one implementation, the method further includes, until receiving an indication to proceed from a user, iteratively displaying the respective results, allowing the user to modify at least one of the one or more relationships or the one or more attributes, generating the at least a portion of the prompt for each segment based, at least in part, on the at least one of the one or more relationships or the one or more attributes as modified by the user, submitting the at least a portion of the prompt for each segment to the at least one generative AI, and receiving updated respective results from the at least one generative AI for each segment.

In some implementations, the method further includes selecting the at least one generative AI from a plurality of generative AIs based, at least in part, on at least one of the one or more attributes or the one or more relationships.

According to some examples, the method additionally includes submitting a prompt to a generative AI to perform at least one of defining the plurality of segments, determining the one or more relationships, or determining the one or more attributes.

In additional examples, the specification data for the first document includes a second document to which the first document is to be responsive. The second document includes an outline structure, and defining the plurality of segments for the first document includes defining the plurality of segments, at least in part, based on the outline structure of the second document.

In other examples, the specification data for the first document includes a second document of a similar type as the first document. The second document includes an outline structure, and defining the plurality of segments for the first document includes defining the plurality of segments, at least in part, based on the outline structure of the second document.

According to some configuration, the specification data for the first document is at least partially obtained automatically from an online source, such as online court records.

According to another aspect, a system for automatically generating a first document using generative artificial intelligence (AI) includes an input interface configured for receiving a request to generate the first document, where the request includes specification data for the first document. The system also includes a processor configured for defining a plurality of segments for the first document based, at least in part, on the specification data, determining one or more relationships between one or more of the plurality of segments based, at least in part, on the specification data, determining one or more attributes for each of the plurality of segments based, at least in part, on the specification data, and generating at least a portion of a prompt for each segment based, at least in part, on at least one of the one or more relationships and the one or more attributes. The system further includes a network interface configured for submitting the at least a portion of the prompt for each segment to at least one generative AI and receiving respective results from the at least one generative AI for each segment, where the processor is further configured for combining the respective results to generate the first document if multiple prompts were generated.

According to yet another aspect, a non-transitory computer-readable storage medium comprises program code that, when executed by at least one processor, cause the at least one processor to perform a method for automatically generating a first document using generative artificial intelligence (AI) including: receiving a request to generate the first document, wherein the request includes specification data for the first document; defining a plurality of segments for the first document based, at least in part, on the specification data; determining one or more relationships between one or more of the plurality of segments based, at least in part, on the specification data, determining one or more attributes for each of the plurality of segments based, at least in part, on the specification data; generating at least a portion of a prompt for each segment based, at least in part, on at least one of the one or more relationships and the one or more attributes; submitting the at least a portion of the prompt for each segment to at least one generative AI; receiving respective results from the at least one generative AI for each segment; and combining the respective results to generate the first document if multiple prompts were generated.

The disclosed system and method assists users (or their agents) by creating output from a generative AI System that is specifically tailored to their preferences. For example, the system may learn about these preferences by reviewing existing data related to the user (e.g., stored preferences, media created or modified by the user, media not created or modified by the user but identified as useful, etc.) or by monitoring a user's interactions (e.g., by observing how users interface with media, messaging interactions, searching interactions, social media interactions, etc.). These preferences are then included in modification information that automatically enhances the users' requests to the generative AI.

In some embodiments, modification information could be provided to the AI by modifying requests sent by the user to the generative AI, or by providing modification information directly to the user for manual inclusion in a request, or by some other means. As a result of the disclosed system's introduction of modification information into the user's requests to the generative AI System, generated responses from that system may be more specific to user needs and preferences, and thus the disclosed system may enhance the users' experience with generative AI Systems.

For example, consider the case above where the user wanted to generate an essay through a generative AI System. Conventionally, the prompt, “write an essay on the city of Dumaguete, Philippines,” will generate a generic response, as discussed above. However, using the disclosed system, such a simple prompt may result in a response from the generative AI System that is completely customized to the users' preferences. The disclosed system may accomplish this by learning about user preferences from a plurality of learning sources, such as, but not limited to, (a) the user's existing body of written work, (b) how the user edited previously generated written work, (c) the follow-up requests the user provided to the generative AI System to change to previous written work, (d) existing stored user preferences or other user history information, (e) written work not created by the user but which the user (or their agent) has identified as useful for generating preferences, and/or (f) any other source determined to be useful. The sources in this example are focused on text or written work but would be different if the example were for a different type of media (e.g., a video-focused example may review some video-centric data). The disclosed system may make determinations based upon learning derived from these learning sources about what enhancements can be made to the prompt to make the resulting text more aligned with the user's preferences. In this example, the disclosed system may make the determination that the user prefers essays that are limited to 500 words, perhaps because her favorite essays are 500 words or because she always edits generated essays to be about 500 words. The disclosed system may then add the phrase “limit to 500 words” to the request prompt that is sent to the generative AI System. Or the disclosed system may modify the request prompt to include the phrase “use the first person” because it determined that the user prefers essays written in the first person, perhaps because in previous essays she has provided a follow-up prompt to the generative AI stating, “change this to first person.” These examples illustrate very simple cases from the myriad ways that the disclosed system can learn from the learning sources and subsequently modify a request to a generative AI System to better meet the needs or preferences of a user when generating or modifying any manner of media.

Note that the action of “modifying requests to” a generative AI System can occur internally within a single system. The disclosed system sometimes describes separate components or systems, but in many cases, several of the disclosed components would be a native part of single system, such as generative AI System itself, and some of the modifications discussed would be internal to that single system.

Another aspect of the disclosed system is that, in addition to enhancing requests from single generative AI Systems, it also helps users select between AI Systems, between outputs from several AI Systems, or between different AI models in a single AI System. This aspect of the disclosed system may automatically generate outputs from multiple generative AI Systems and make a determination about which output (or combination of outputs) is best suited for the user's needs under the circumstances. Or in some cases it may make a determination about which generative AI System best matches the user's needs in advance and only request a response from the system (or combination of systems) determined to be appropriate for the user under the circumstances. In some cases it may work within an AI System to make a similar determination about which model, source, algorithm, or other element within the AI System may produce results most appropriate for the user under the circumstances. Determinations about what plurality of AI Systems to select, what model or algorithm to select within an AI System, or whether to select them in advance or after receiving responses, may be learned from various learning sources (such as the learning sources discussed above). This selective aspect of the disclosed system can help users select and merge data from different AI Systems, models, algorithms, etc. based upon their individual preferences.

For example, again consider the scenario above where the user is generating an essay about the Philippines. This selective aspect of the disclosed system would allow the user to generate essays from a plurality of generative AI Systems. The disclosed system could then automatically determine which of the generated responses best fit the user's needs or preferences. Alternatively, the disclosed system could determine in advance which generative AI System is most likely to generate the best results for the given case and only request from that system. This pre-selection may be useful if some generative AI Systems were more expensive than others, in which case cost information may be a factor in such a decision. The disclosed system may also combine responses from multiple systems to create the best combined outcome. Such determinations may be made based upon the learned habits and preferences of the user as discussed in the previous examples and specifications, or they may involve requesting input from a user during operation. In this example, the essay about the Philippines could be drawn from several sources (e.g., GPT, PaLM, and LLaMA). The disclosed system could then use the learned user preference from the sources discussed above to determine which of the three essays best matches the user's preferences. Alternatively, it may create a combination of results from the different sources, either by using learned user preferences or by asking the user which portions it prefers (e.g., by prompting to user with “which version of this sentence do you prefer?”). In other embodiments, the disclosed system may break the request into several sub-requests to use benefits of each AI System, model, or other AI element (e.g., “write an intro paragraph about . . . ” is sent to GPT, “write a paragraph about the people of . . . ” is sent to PaLM, and “write a conclusion paragraph about . . . ” is sent to LLaMA) and the results could be merged to provide a hybrid result. As with other examples, different media content may be handled differently.

As previously discussed, generative AI Systems will generally produce small variations in the document each time it is generated. A user may want to rely on these systems to consistently create the desired language for a complex legal document, but no conventional AI Systems exist to achieve this goal. According to another aspect, the disclosed system overcomes the deficiencies of conventional approaches, in part, by breaking down large legal (or other) documents into component pieces. Thereafter, the disclosed system will allow the user to edit the component pieces of the complex legal document in manageable segments. Such editing may include providing details within these component pieces that may be used by the generative AI in producing the final result. Finally, the disclosed system may use these component pieces to produce a final legal document that needs a little, if any, editing.

### BRIEF DESCRIPTION OF THE DRAWINGS

FIG. 1 illustrates a manner in which a User Specific Learning Manager (USLM) may monitor, modify, and forward requests and responses between a User Agent and an AI System.

FIG. 2 illustrates some example learning sources through which the USLM may learn about user preferences.

FIG. 3 illustrates a process by which user editing activities may be monitored to assist in learning about user preferences.

FIG. 4 illustrates how user generated modification requests and subsequent responses may be monitored to assist in learning about user preferences.

FIG. 5 illustrates how user or third party feedback may assist in learning about user preferences.

FIG. 6 illustrates how requests to and responses from multiple AI Systems may be automatically managed.

FIG. 7 illustrates how the entire system may be structured as part of a single AI System.

FIG. 8 illustrates an overview of the components in the disclosed system.

FIG. 9A illustrates a Document Segments Tree organized with a plurality of Document Segments in a tree structure.

FIG. 9B illustrates a Document Segment containing a plurality of Attributes and a plurality of Relationships.

FIG. 9C illustrates a Document Segment that contains example Attributes and example Relationships.

FIG. 10 illustrates an example Document Segment Tree editing process.

FIG. 11 illustrates operation of the Generative AI Synchronization Module.

FIG. 12 illustrates a method in accordance with the present disclosure.

FIG. 13 illustrates an example computer system for implementing the methods disclosed herein.

### DETAILED DESCRIPTION

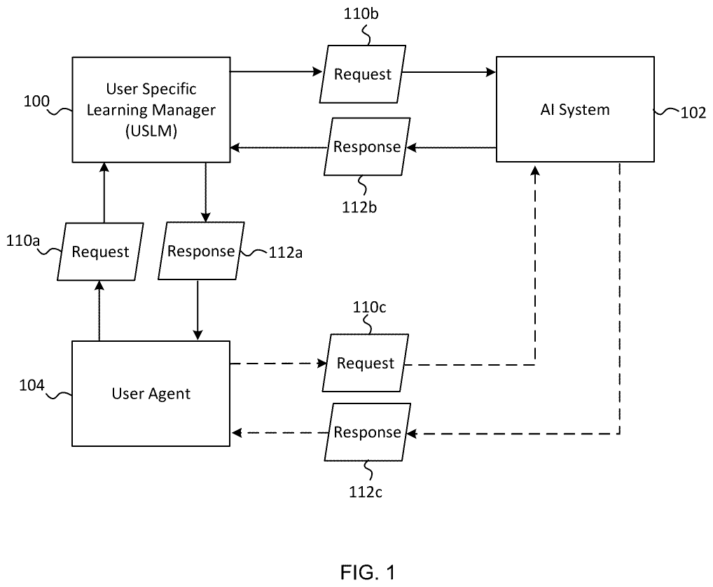

FIG. 1 illustrates how a User Specific Learning Manager (USLM) 100 may monitor, modify, and forward requests 110a from a User Agent 104 and responses 112b from an generative AI System 102 by (a) accepting requests 110a from the User Agent 104 and monitoring or modifying them before forwarding such requests 110b to the AI System 102, and (b) accepting responses 112b from the AI System 102 and monitoring or modifying them before forwarding such responses 112a to the user. As used herein, the USLM 100 is any process that learns from User Agent 104 activities and subsequently modifies or routes requests directed to an AI System 102 in an attempt to improve the resulting response generated by the AI System 102 or by selecting or anticipating the AI System 102 with the likely best response. This process could be implemented by algorithms, machine learning, or artificial intelligence. It could be implemented through hardware, software, firmware, or a combination thereof. The USLM 100 can be part of any other process or function and need not stand alone. In this document, all references to the USLM 100, learning manager, learner, or similar references shall be construed as references to this definition, or a broader definition as established by their use in context. References to the disclosed system “learning” should be similarly construed.

The AI System 102 include any artificial intelligence systems that receive input and subsequently generate output based to correspond to such input. Examples can include, but are not limited to, systems that generate text, video, audio, images, 3D models, computer code, binary results, structured data, and many other forms of media or output. Such systems also include processes for modifying or editing, not necessarily generating, works of any of the previously mentioned types of media or outputs. The AI System 102 can be a stand-alone system or AI components inside another system. The use of the term “generative” AI Systems should not be construed as a restriction to systems that are categorized as “generative” within the art. For the purposes of this document, any system that takes input and generates a subsequent output can be considered a generative AI System 102, even if it may be categorized otherwise under current or future usage of the term. In this document, all references to AI Systems, generative AI Systems, generative AI, or similar references shall be construed as references to this definition, or a broader definition as established by their use in context. For example, the AI System 102 may be any suitable generative AI System, non-limiting examples of which may include OpenAI GPT, Google PaLM 2, Meta LLaMA, Lex, Dall-E 2, Midjourney, Stable Diffusion, Amper, Dadabots, MuseNet, CodeStarter, Codex, GitHub Copilot, Tabnine, Descript, Listnr, and Podcast.ai. In some configurations, the AI System 102 may include multiple AI Systems 102.

User Agents 104 can be a person or process that makes requests to and receives responses from a generative AI System 102. The disclosed system supports a plurality of User Agents 104 and can track each user separately to provide them each with the benefits of the disclosed system. This includes both human users or software processes. In this document, all references to User Agents or users shall be construed as references to this definition, or a broader definition as established by their use in context. In some cases, the User Agent 104 may communicate requests 110c to, or receive responses 112c directly from the AI System 102. In cases where the User Agent 104 communications directly with the AI System 102, the USLM 100 may also receive copies of such requests 110a and responses 112b.

Requests e.g., 110a, 110b, 110c represent an input to an AI System 102 that provide information about what an output that may be generated. These inputs can be text, binary, structured data, vectors, unstructured data, numbers, video, audio, images, other media, Boolean values or other forms of input. Many of the examples in this document use the example of text prompts, such as “write a letter from me to customer A.” However, these examples are used primarily because they make the specification easier to understand. In such examples, an AI System 102 may instead require a vector input containing instructions that are not human-readable. In this document, all references to Requests, prompts, inputs, and similar terms shall be construed as references to this definition, or a broader definition as established by their use in context. For example, a prompt may not necessarily refer to a natural language prompt in the context of a generative AI system, but could include code that is not readable by a human.

Responses e.g., 112a, 112b, 112c represent the output of an AI based upon inputs provided. These responses can be text, numbers, vectors, images, video, audio, other media, structured data, unstructured data, or other forms of output from an AI System 102. Many of the examples in this document focus on text outputs. These examples are used to create easily readable examples for the purposes of explaining this disclosed system. The use of text examples for responses should not be construed in any way to limit the disclosed system to text-based AI responses. Responses, outputs, generated text, and similar terms shall be construed as references to this definition, or a broader definition as established by their use in context.

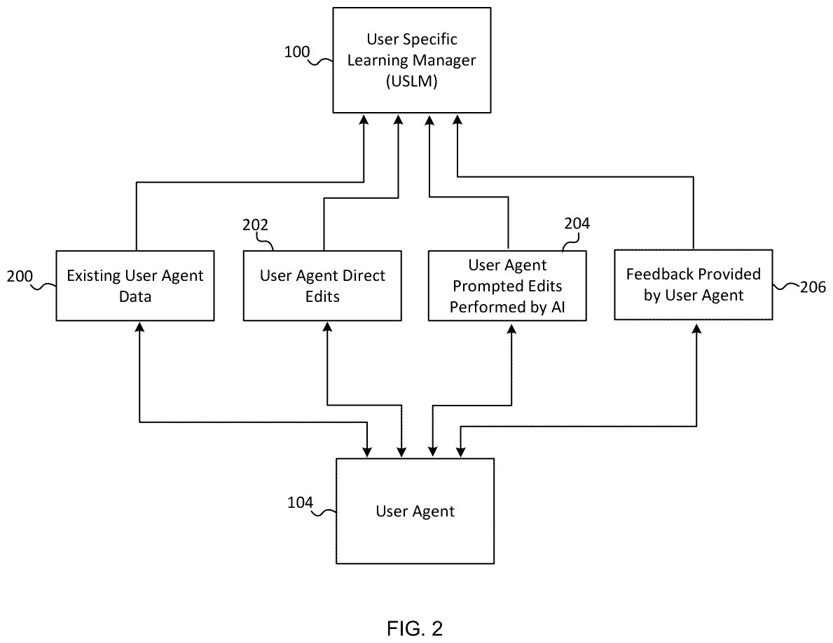

FIG. 2 illustrates some example learning/data sources (e.g., 200, 202, 204, 206) by which the USLM may learn about user preferences. Existing User Data 200 may include information that exists prior to a determination that is deemed useful for such a determination (e.g., samples of a user's previous work, stored user preferences, etc.). User Agent Direct Edits 202 may originate from monitoring the User Agent's 104 interactions with responses, both current and previous, from the USLM 100 (or, in some cases, directly from other sources). User Agent Prompted Edits Preformed by AI 204 may originate from monitoring the changes, both current and previous, that the User Agent 104 requests from the USLM 100 or the AI System 102 that modify an existing request already received by the User Agent 104. Feedback Provided by User Agent 206 is information learned from feedback from the User Agent 104 (or sometimes other sources) about a response. The USLM 100 may use all of these sources to learn about the preferences of the User Agent, as well as other sources as needed.

Existing User Data 200 may include any data that can be used to learn user preferences. For example, preset user preferences, media created by the user, media created by sources other than the user but that have been identified as useful for determining user preferences, user history information (e.g., history of messages, chats, searches, etc.), and other information that exists prior to a determination deemed useful for such a determination. In some cases, such data may also include data that may be merged into responses or requests, such as customer lists, templates, logos, stock photos, and other reusable content. Existing user agent data, user data, and similar terms shall be construed as references to this definition, or a broader definition as established by their use in context.

User Preferences or preferences means results that may be preferred by the user over other potential results. This definition should not be limited by how the term “preferences” is used in this or other arts. User preferences, preferences, and similar terms shall be construed as references to this definition, or a broader definition as established by their use in context.

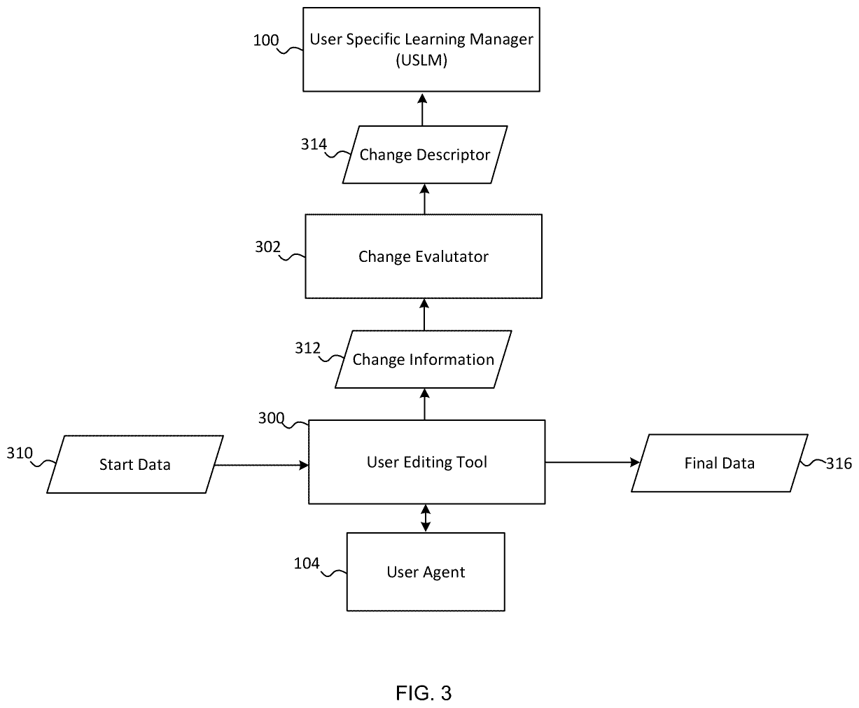

FIG. 3 illustrates how a User Agent 104 interacts with a User Editing Tool 300 to edit Start Data 310, which may include data from a response (e.g., 110a) to create Final Data 316, which represents the completion of the User Agent's 104 current editing of the Start Data 310. For example, a User Editing Tool 300 might be a plugin for Microsoft Word where a User Agent 104, in this example a person, is editing a document. Here the Start Data 310 is an original version of the document. During such editing, changes are monitored by reviewing what changes the User Agent 104 makes in the User Editing Tool 300 and sending such Change Information 312 to a Change Evaluator 302 that digests such Change Information 312 into a Change Descriptor 314 that is used to learn about user preferences in the USLM 100. In the example, as the user makes changes to the document in Microsoft Word, the changed portions of the documents as well as the original information that was replaced are sent to the Change Evaluator 302 in the form of Change Information 312. In the Change Information examples provided below, the SegmentID and CharID are exemplary of how a changed portion of a document might be labeled in Change Information to help the system track where in the document the change occurred. This information is optional and it can be optionally stored later with the resulting change information. In some cases, the Change Evaluator 302 may be unnecessary if the USLM is equipped to handle the raw Change Information 312. In the example, the Change Evaluator 302 uses an LLM to evaluate the difference between the original text and the changed text as it was described in the Change Information 312 and retrieves attributes from those changes that it sends to the USLM in the form of a Change Descriptor 314.

Table 1 illustrates two examples of how a User Agent 104 interacts with a User Editing Tool 300, as described in FIG. 3, as well as how a change descriptor is used in future generation requests to an AI system during document creation.

TABLE 1

| | Example 1: Simple Sentence, | Example 2: Code Style |
|---|---|---|
| | Adds Oxford Comma | Change |
| 310 Start Data | A document containing the | A segment of code containing |
| | sentence “At the store I purchase | the line “int |
| | hotdogs, mustard and buns.” | my_variable_name = 0;” |
| 312 Change Information | “At the store I purchase hotdogs, | “int my_variable_name = 0;” |
| In this example, the change | mustard and buns.” changed to | changed to “int |
| was made by the user in the | “At the store I purchase hotdogs, | variableName; variableName = |
| 300 User Editing Tool | mustard, and buns.” | 0;” [SegementID = 10; |
| | [SegementID = 1; CharNum = 1;] | CharNum = 1;] |
| 302 Change Evaluator | External AI Used in This | External AI Used in This |
| In this example, an external | Example: Chat GPT-4 | Example: Chat GPT-4 |
| AI is queried to get a | | |
| description of the change | | |
| made by the user to gather | | |
| the change's attributes to | | |
| include in a change | | |
| descriptor | | |
| 302 Change Evaluator | Create a list of formatting, | Create a list of formatting or |
| Example request sent by | grammar, or, general tone, or | stylistic attributes or |
| the change evaluator to the | stylistic attributes. Only list one | preferences that have changed |
| external AI to get change | change per item, aiming for | between the two snippets in |
| attributes for 314 Change | brevity and clarity in your | quotes. Only make a list of |
| Descriptor | descriptions. Use the present | one item per change without |
| | tense, and ensure that these | duplicates. Be concise, try to |
| | attributes can be generalized to | explain the changes in 6 |
| | other texts, so do not include | words or less, 3 is fine for |
| | anything specific to this text (e.g., | simple changes. Make |
| | names, dates, specific words). | descriptions generic because |
| | The sentences are: “At the store I | they will be applied to code |
| | purchase hotdogs, mustard and | that is not the same. |
| | buns.” and “At the store I | Remember this is code, so |
| | purchase hotdogs, mustard, and | don't list things that change |
| | buns.” | functionality, just format and |
| | | style. Describe in the present |
| | | tense. The two sentences are: |
| | | “int my_variable_name = 0;” |
| | | changed to “int variableName; |
| | | variableName = 0;” |
| 314 Change Descriptor | 1. Adds serial comma: Before | 1. Adopts camelCase: |
| Generated by External AI | conjunction. | Changes variable naming. |
| from response to request | | 2. Splits |
| above in this example | | declaration/initialization: |
| | | Separates into two lines. |
| | | 3. Adds semicolon: |
| | | Introduces additional |
| | | punctuation. |
| 316 Final Data | The original document with the | The original code with the |
| | user's changes, in this case the | user's changes, in this case |
| | introduction of the comma in the | the code lines: |
| | sentence: “At the store I purchase | “int variableName; |
| | hotdogs, mustard, and buns.” | variableName = 0;” |
| Example of how Change | | |
| Descriptor is used in | | |
| future generation of | | |
| requests to AI system | | |
| during document creation | | |
| (for illustrative purposes | | |
| only) | | |
| New Request Including | Change the text in ## to include | Change the code in ## to |
| Change Descriptor | the attributes below: | include the attributes below: |
| | 1. Adds serial comma: Before | 1. Adopts camelCase: |
| | conjunction. | Changes variable naming. |
| | ## | 2. Splits |
| | The man ate an apple, a grape and | declaration/initialization: |
| | an orange. | Separates into two lines. |
| | ## | 3. Adds semicolon: |
| | | Introduces additional |
| | | punctuation. |
| | | ## |
| | | int here_is_my_var = 1; |
| | | double here_is_another_var = |
| | | 10.0; |
| | | ## |
| Response | The man ate an apple, a grape, | int hereIsMyVar; |
| | and an orange. | hereIsMyVar = 1; |
| | | double hereIsAnotherVar; |
| | | hereIsAnotherVar = 10.0; |

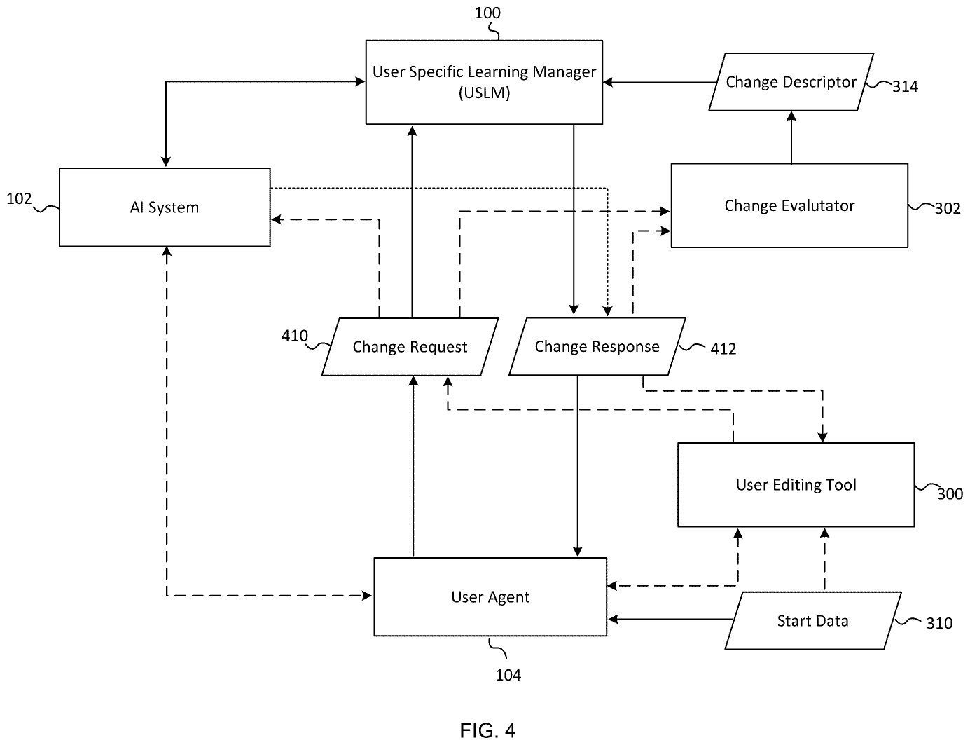

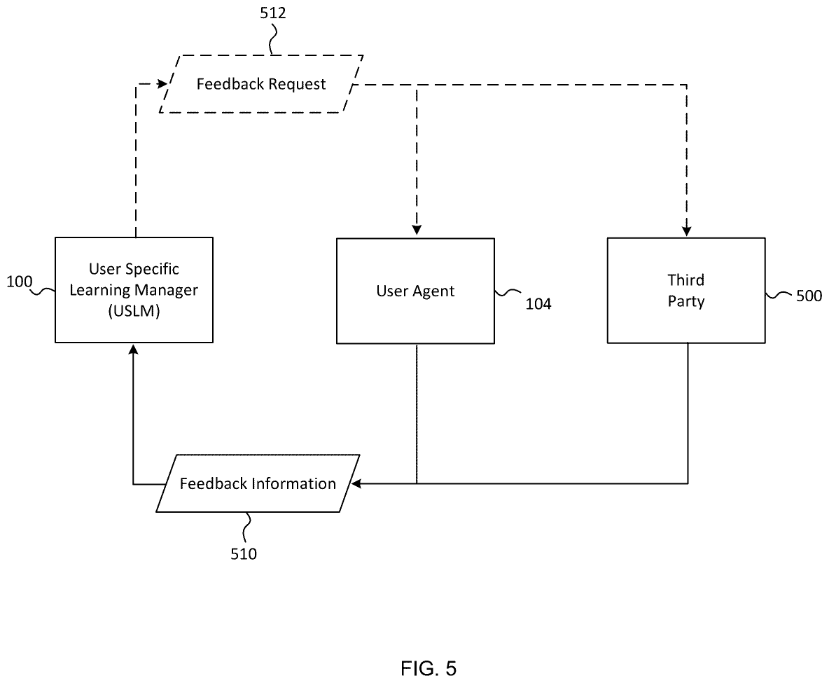

FIG. 4 illustrates how the USLM 100 can learn from changes made by a User Agent 104 to Start Data 310, which may include data from a response (e.g., 110a). After receiving the Start Data 310, the User Agent 104 provides a Change Request 410 to the USLM 100 (or in some cases directly to the AI System 102). In an example of the process described in FIG. 4, the User Editing Tool 300 might be the same plugin for Microsoft Word used in the example above, but here the User Agent 104, which is still a person, does not directly change the text in the Start Data 310. Instead the User Agent 104 submits a Change Request 410 to the USLM 100, or directly to an AI System 102, to request that the system makes a change to the text. The USLM 100 may query the AI System 102 using an original or modified version of the Change Request 410 and receive a response. The USLM 100 may then provide an original or modified version of the response as a Change Response 412 to the User Agent 104 or directly to the User Editing Tool 300. In the example, this Change Response 412 contains the result of the change that the User Agent 104 requested. The USLM 100 may learn directly from this information exchange or may employ a Change Evaluator 302 to assist it in digesting such changes into a Change Descriptor 314. In some cases, this process may be integrated into the User Editing Tool 300, as it is in the example below. The USLM might additionally track whether a user accepted or rejected a Change Response 412 in the User Editing Tool 300 (e.g., by not accepting a change through Microsoft Word's track changes feature or the process illustrated in FIG. 5) and not include rejected changes in its learning process.

Table 2 illustrates a change evaluation example with a user-generated request for a change.

TABLE 2

| | Example 3: Simple Sentence Tone Change |
|---|---|
| 310 Start Data | A document with the sentence “Go get the |
| | staples right now. I won't tell you again.” |
| 410 Change Request | “Make this sentence friendlier and more |
| Generated by the User by highlighting text in | positive.” |
| the 300 User Editing Tool and then typing this | |
| example change request | |
| 100 USLM | In this example, the USLM Generates a |
| | request for an external AI system to make the |
| | User's desired change. |
| 100 USLM Sub-process | Change this sentence: “Go get the staples |
| Generated by the 100 USLM and sent to an | right now. I won't tell you again.” to be |
| external AI to process the requested change | friendlier and more positive. |
| 100 USLM Sub-Process | “Could you please grab the staples when you |
| Received from the external AI in response to the | have a moment? Thank you!” |
| above request, used to make User's desired | |
| change in 300 User Editing Tool and sent to 302 | |
| Change Evaluator | |
| 302 Change Evaluator | In this example, the change evaluator uses a |
| | sub-process similar to the examples provided |
| | for FIG. 3 where an external AI is queried to |
| | provide a description of the changes. This |
| | process creates the 314 Change Descriptor. |
| 314 Change Descriptor | DOCUMENT CATEGORY: Email to |
| | subordinate |
| | SECTION CATEGORY: Request for action |
| | CHANGES: |
| | 1. Command form is changed to be friendlier. |
| | 2. Expresses gratitude during requests. |

FIG. 5 illustrates how the USLM 100 can learn from feedback provided by a User Agent 104 or a Third Party 500. The USLM 100 may optionally request feedback through a Feedback Request 512 sent the User Agent 104 or a Third Party. A Feedback Request 512 to a user might include a simple message on the side of a Word Document that says, e.g., “Did you like this change?” The Feedback Request 512 may include “thumbs up” icon and a “thumbs down” icon that can be selected. In a more complex example, the USLM might have a text-to-speech and speech-to-text feature that allows the User and the USLM to have a detailed conversion about what the User liked and disliked about the document so that such changes might be incorporated in future documents. In that case there would be a cycle of Feedback Requests and Feedback Information that form the conversation. An example of a Feedback Request 512 to a third party could include an email requesting that the third-party complete a survey about their opinions on a generated document, like web page content. In another example, the Feedback Request 512 is a created when the system generates messages in a chat forum to solicit feedback about posted material that was generated by the system. In that case, the user might have used the system to generate a social media post and the system generates messages in the post's comments section designed to elicit feedback from third parties feel about the generated content. A User Agent 104 or a Third Party can provide feedback through Feedback Information 510. Such Feedback information may include feedback on the sender's opinion about the quality of a Response 112a that the USLM may use to learn about a user's preferences. Correlated to the examples above, in the first example, the Feedback Information is yes or no corresponding to the thumbs up or thumbs down icons that indicate whether the user was happy with the result. In the conversational example, the Feedback Information is every response in voice-to-text generated by the User during the conversation. In the survey example, the Response Information is the result of the survey completed by the third party about the content. In the post comments example, the Response Information is the replies to the comments soliciting feedback about the generated post. Third party feedback may be useful when the Third Party 500 has information that is important to the user's preferences, such as the opinion of a supervisor or customer.

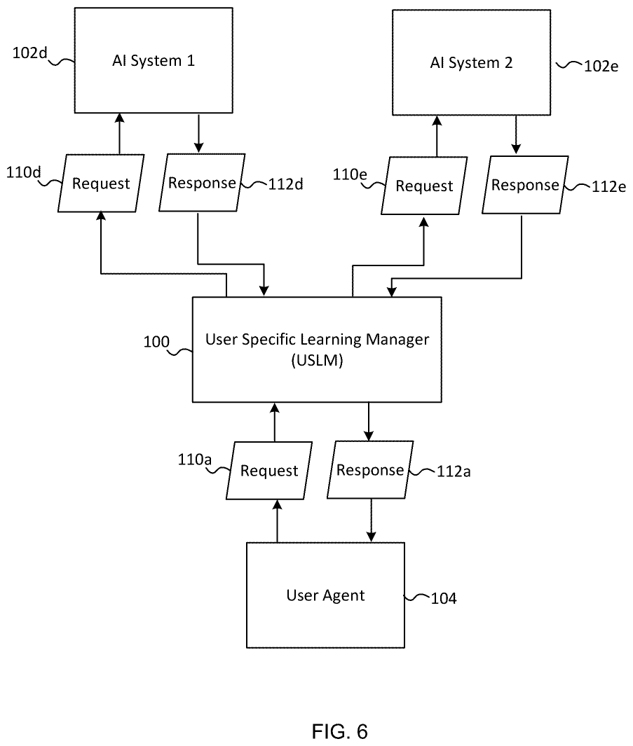

FIG. 6 illustrates how the USLM 100 may assist the User Agent 104 in selecting between two (or more) AI Systems 102d and 102e. The User Agent 104 sends a Request 110a to the USLM 100, which forwards original or modified versions of the Request (e.g., 110d and 110e) to a plurality of AI Systems (e.g., 102d and 102e). The plurality of AI Systems 102d and 102d may be of the same type or different types. In some cases, the USLM 100 may determine in advance that only a subset of the plurality of AI Systems will receive such Requests (e.g., 110d may be sent to 102d). Alternatively, in some cases, the USLM 100 may break the request into component sub-requests that it sends as different Requests (e.g., 110d and 110e) to a plurality of AI Systems (e.g., 102d and 102e). In any case, the USLM 100 will receive Responses (e.g., 112d and/or 112e) and determine which response or combination of responses may be sent as a Response 112a to the User Agent 104. In some cases, the AI Systems 102d and 102e are actually different models, algorithms, or other elements within a single AI System when selecting between such different elements, or providing the same element with a different prompt, may produce a different response. In one example, the USLM 100 sends Requests 110d and 110e to two different AI Systems 102d and 102e and will compare the results from those systems as encapsulated in Reponses 112d and 112e. The USLM 100 might compare the two results by using an LLM to match the returned results against the learned preferences of the user. The selected result will be returned to the User Agent 104 in Response 112a. An example of a simple selection between two AI systems based on evaluation of results is shown below in Table 3.

| 110a Original | Write a short paragraph arguing that Plaintiff could not have been injured by | |
|---|---|---|
| User Request | Defendant's products because the alleged defective product batches were not | |
| | available in stores until after the date of Plaintiff's purchase. | |
| 100 USLM | In this example, the USLM decides to send the request to both AIs and | |
| Decision | evaluate the results. | |
| 110d, 110e | Write a short paragraph arguing that | [Same request sent to both systems |
| Requests to | Plaintiff could not have been injured | in this example because selection |
| Multiple AIs | by Defendant's products because the | will occur after results arrive.] |
| (Modified by | alleged defective product batches | |
| USLM in this | were not available in stores until after | |
| example to include | the date of Plaintiff's purchase. The | |
| attributes and | products were purchased by Plaintiff | |
| information not in | in December of 2023. Defendant | |
| Original User | shipped alleged defective batches in | |
| Request, per | January of 2024. Paragraph length | |
| invention design) | should be 4 sentences. Begin with | |
| | topic sentence. End with Conclusion. | |
| | Be persuasive. Audience is a judge. | |
| | Be deferential. Be specific. Use | |
| | logical reasoning. This is a short | |
| | paragraph inside a longer document, | |
| | so it does not need to stand alone -- | |
| | do not address the audience directly. | |
| 102d, 102e AI | Chat GPT-4 | Google Gemini |
| Systems Used in | | |
| Example | | |
| 112d, 112e | The timeline of events substantiates | Plaintiff could not have been injured |
| Responses from | the defense's position that the | by Defendant's products because the |
| Multiple AIs | Plaintiff could not have been injured | alleged defective batches were not |
| | by the products alleged to be | shipped until January 2024, a full |
| | defective. The products in question | month after Plaintiff's December |
| | were purchased in December of 2023, | 2023 purchase. It is therefore |
| | while the batches labeled as defective | logically impossible for Plaintiff to |
| | were not shipped by the Defendant | have acquired and been harmed by |
| | until January of 2024. This clear | these defective products. |
| | sequence of events indicates that the | Consequently, Defendant cannot be |
| | Plaintiff's purchase predated the | held liable for injuries allegedly |
| | availability of the defective products. | caused by products that were not |
| | Therefore, the claims asserting injury | available to the public at the time of |
| | from these batches lack factual | Plaintiff's purchase. |
| | foundation and must be reconsidered | |
| | on this basis. | |

| | |
|---|---|
| 100 USLM | USLM decides between the two results. For example, by comparing them to |
| Decision | the User's previous body of work, by using an LLM to evaluate their |
| | strengths and weaknesses relative to the know User preferences, or by |
| | presenting them to the User and allowing the User to choose the preferred |
| | result. |
| Example Selected | 102e from Google Gemini |
| Result | |
| 112a Response to | Plaintiff could not have been injured by Defendant's products because the |
| User Agent | alleged defective batches were not shipped until January 2024, a full month |
| | after Plaintiff's December 2023 purchase. It is therefore logically impossible |
| | for Plaintiff to have acquired and been harmed by these defective products. |
| | Consequently, Defendant cannot be held liable for injuries allegedly caused |
| | by products that were not available to the public at the time of Plaintiff's |
| | purchase. |

In another example, the USLM 100 decides which of the AI Systems 102d and 102e to use in advance and only sends either Request 110d or Request 110e. Such a decision could be made by determining which of these two systems is most appropriate for the task at a hand. For example, if the USLM 100 has received more positive feedback about AI System 1's generation of text for social media posts and the current task requires generating such a post, then the USLM 100 could select AI System 1 102d for the task. In this example, the Request 110d would only be sent to the AI System 102d and its Response 112d would be returned by the USLM 100 to the User Agent 104 in the form of a Response 112a. An example of a simple pre-selection between two AI systems based on previous user preference is found below in Table 4.

TABLE 4

| 110a Original | Write a short paragraph arguing that Plaintiff could not have been injured | |
|---|---|---|
| User Request | by Defendant's products because the alleged defective product batches | |
| | were not available in stores until after the date of Plaintiff's purchase. | |
| 100 USLM | In this example, the USLM determines that previous user preferences | |
| Decision | show that Google Gemini is preferred by the User for argumentative | |
| | paragraphs and the USLM will pre-select that AI to perform the task | |
| 110d, 110e | [no request sent] | Write a short paragraph arguing that |
| Requests to | | Plaintiff could not have been injured |
| Multiple AIs | | by Defendant's products because the |
| (Modified by | | alleged defective product batches |
| USLM in this | | were not available in stores until |
| example to include | | after the date of Plaintiff's purchase. |
| attributes and | | The products were purchased by |
| information not in | | Plaintiff in December of 2023. |
| Original User | | Defendant shipped alleged defective |
| Request, per | | batches in January of 2024. |
| invention design) | | Paragraph length should be 4 |
| | | sentences. Begin with topic sentence. |
| | | End with Conclusion. Be persuasive. |
| | | Audience is a judge. Be deferential. |
| | | Be specific. Use logical reasoning. |
| | | This is a short paragraph inside a |
| | | longer document, so it does not need |
| | | to stand alone -- do not address the |
| | | audience directly. |
| 102d, 102e AI | Chat GPT-4 | Google Gemini |
| Systems Used in | | |
| Example | | |
| 112d, 112e | [no request sent and no response | Plaintiff could not have been injured |
| Responses from | received] | by Defendant's products because the |
| Multiple AIs | | alleged defective batches were not |
| | | shipped until January 2024, a full |
| | | month after Plaintiff's December |
| | | 2023 purchase. It is therefore |
| | | logically impossible for Plaintiff to |
| | | have acquired and been harmed by |
| | | these defective products. |
| | | Consequently, Defendant cannot be |
| | | held liable for injuries allegedly |
| | | caused by products that were not |
| | | available to the public at the time of |
| | | Plaintiff's purchase. |

| | |
|---|---|
| 100 USLM | The USLM does not make a decision here because the AI was pre-selected |
| Decision | in this example. |
| Example Selected | 102e from Google Gemini (only option in this example) |
| Result | |
| 112a Response to | Plaintiff could not have been injured by Defendant's products because the |
| User Agent | alleged defective batches were not shipped until January 2024, a full |
| | month after Plaintiff's December 2023 purchase. It is therefore logically |
| | impossible for Plaintiff to have acquired and been harmed by these |
| | defective products. Consequently, Defendant cannot be held liable for |
| | injuries allegedly caused by products that were not available to the public |
| | at the time of Plaintiff's purchase. |

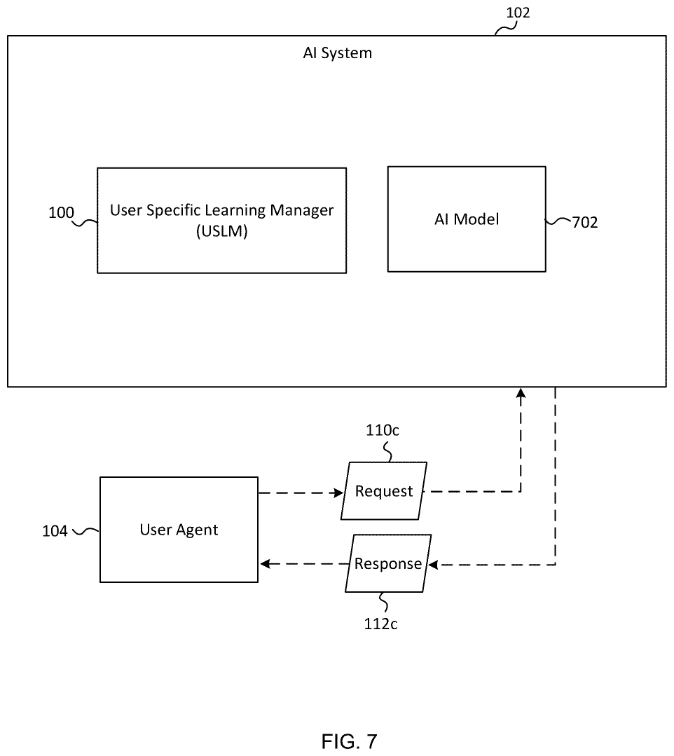

FIG. 7 illustrates how, in some cases, the AI System 102, or another system, may contain multiple elements in a single system. In this figure, the User Agent 104 is interacting directly with the AI System 102 that contains a learning system that may modify instructions to the system's AI Model 702 to provide output information tailored for user preferences. Embodiments of learning systems might include a reinforcement learning system, a neural network, a database, or any other systems capable of storing and selecting user preferences and other information. For example, a very simple implementation of a learning system might be a database of stored attributes collected from the system's data, like Change Descriptors, that the system has gathered. The system could then be queried to find attributes from those data that apply to a current document. In this example, if the user is sending an email to a client, this simple implementation might query a database for attributes associated with emails to clients when constructing new requests for generative AI systems. In another learning system implementation example, the learning system can be implemented through a fine-tuning feature operatively connected to the generative AI. In this example the data collected from the system's data, like Change Descriptors, could be fed into a generative AI's fine-tuning feature to help the AI system be more responsive.

### Text-Focused System Implemented Through Reinforcement Learning

In one embodiment, the learning mechanism of the USLM 100 may be implemented using reinforcement learning (“RL”). This example embodiment may be targeted at a system designed to improve the quality of text generated AI results. However, the RL learning mechanism described in this example could be used to learn about and improve any media type using this disclosed system. This example embodiment is also focused on a single type of media (text), but embodiments may process any number of media concurrently.

In this implementation, as in many other implementations, an implementor may determine how the components of the learning mechanism used to implement the USLM (here RL) may be mapped to elements of the disclosed system such as requests, responses, change descriptors, and other elements. In this example embodiment, the RL used for the learning mechanism may include the following components: an environment, a state, and a reward function. As described below, each of these RL components may be operatively connected to elements of the disclosed system to provide the desired learning capabilities.

In this embodiment, the RL environment is represented by a series of variables of any type (e.g., vector). These variables may include the type of media being used, the current User Agent 104, the type and sub-type of document being created, paragraph type, sentence type, connected AI Systems 102, the state of the interaction between the AI System 102 and USLM 100, tone variables, style, formatting variables, and other variables. In some systems, new variables may be dynamically added as an as-needed basis. These variables would be different if the media were different (e.g., video type instead of document type, segment instead of paragraph, frame instead of sentence).

In this embodiment where RL is the learning mechanism, these variables include a state, which may contain a current value for some or all of the variables that define the environment. Here the USLM 100 may populate these variables using the current state of interaction between the USLM 100 and the AI System 102 (e.g., for things like connected AI Systems 102, or connection statuses, preset values, and information from the current request (e.g., 110a) from the user agent period (“Current Request”). One method for populating these variables is to query the AI System 102 about potential values in the Current Request. For example, if the request states “create a marketing letter to Customer A about Product B,” one method for populating variables for the current state is to query an AI System 102 (“AI Evaluator”) about each variable. The AI evaluator can be the AI System 102 or another AI capable of evaluating the requests for the presence of attributes. One way to accomplish this is to send requests to the AI Evaluator like “What type of document is being requested in this sentence: ‘create a marketing letter to Customer A about Product B.’” Another way to accomplish the same task is to give the AI Evaluator choices like “Categorize this sentence as requesting either a letter, a memo, or an essay: ‘create a marketing letter to Customer A about Product B.’” The results from the AI Evaluator can then be used to assign values to variables in the state. For example, if the AI System 102 returns a response “this is a marketing letter,” then the variable for document type could be assigned to a value associated with the document type of letters, or more specifically to a value or combination of values associated with the document type of marketing letters. Similarly, the other variables can be populated with queries to the AI Evaluator about the Current Request's style, tone, target audience, specific addressee, and many other potential elements that will establish the RL state of the current environment. The process used for the assignment of state values may be different when the media type is different. As an example, an AI evaluator may be asked about a text prompt containing words describing a video (e.g., “what type of video is being described in this statement ‘create a marketing video about product A’) or in some cases the AI evaluator may evaluate the non-text media (e.g., “does this video contain information about product A? [attached video]” or the equivalent in another format). Such evaluations are possible with various media using examples from the generative AI Systems discussed above.

In this embodiment where RL is the learning mechanism, actions may be defined. Actions can be conceptualized as optional steps that may be taken by the RL in furtherance of an objective. Here the actions may be the possible modifications to Current Request that may improve its usefulness to the user. Because this is a text-based example, the Current Request is likely a text prompt and the modifications may include changes to the prompt (e.g., adding phrases to the prompt, like “include discussions of product features” or “use bullet points” or “limit responses to 1000 words”). Non-text implementations may use media-specific modifications. The modifications to the Current Request may be sent to the AI System 102 to receive a response 112a (“Current Response”). These actions taken to modify the Current Request may be used by the RL system in combination with the state, environment, and reward information (explained below) to learn which actions result in the highest reward for any state. This learned information may be used to determine how requests (associated with state) should be modified (by actions) to produce the responses preferred by the user (those with the highest rewards), as explained more below.

RL Actions can also determine which AI Systems 102 will receive the Current Request and how results are selected or merged (when multiple results are received). For example, the marketing letter above could be sent to multiple AI Systems 102 (e.g., GPT and LLaMA) and the results could be evaluated (e.g., by the user or the USLM 100) and the most appropriate result (or combination of results) selected. Or the Current Request may be split into sub-requests sent to several AI Systems 102 (e.g., as GPT for the body but have LLaMA build the letter header). Or the AI System 102 may determine in advance, based on learned user preferences, that a certain AI System 102 (e.g., GPT) is most suited for the current task and send the request only to that system.

Modifications to Current Requests need not be solely based on actions, for example present user preferences, such as “always use the oxford comma,” may be included regardless of whether they are associated with an action in RL.

In this embodiment where RL is the learning mechanism, rewards will help the RL system quantify the value of the Current Response to the User Agent 104. Here, the reward may be determined by any of the methods shown in FIG. 2 (and detailed in other figures), or other methods, or a combination thereof. In this embodiment, any combination of these methods may contribute a reward value (“Reward Contribution”) to a sum that may be used to determine a final reward value for the RL system.

In one example of Reward Contribution, the value of such a reward contribution is quantified by determining how much a User Agent 104 modified the Current Response in a User Editing Tool 300. For example, if the User Agent 104 made substantial modifications to the Current Response in the User Editing Tool 300, the reward would be lower (potentially even negative) than if the User Agent 104 made few changes or unsubstantial changes before concluding that the product was in a Final State, i.e., Final Data 316. The AI Evaluator (used here as the Change Evaluator 302) can be used to determine the substantialness (or other quantifiable aspects) of changes, just as it was used to determine the presence of elements above. An example of such a use of the AI Evaluator may be to send it a request to compare two sentences (e.g., “On a scale of 1 to 10, how different are these sentences: ‘the dog ran’ and ‘the dog ran quickly’”). In another example, the Reward Contribution may be evaluated based upon a series of weighted dimensions evaluated individually and weighted before contributing their Reward Contribution (e.g., the result of the query “On a scale of 1 to 100, how do the following two sentences compare in aggressiveness of their tone: ‘please stop that’ and ‘please stop that right now’” is weighted based on a preset or AI-determined value). See the detailed descriptions related to FIG. 3 above.

In one example of Reward Contribution, a reward is quantified by determining how much a User Agent 104 modifies the Current Response with additional Change Requests 410. Just like in the examples above where the User Agent's changes to the text were evaluated using the AI Evaluator (used here as a Change Evaluator 302), the AI Evaluator can also evaluate either the Change Request 410 itself or the difference between the Current Response and its Change Response 412. Through this process, a value for a reward contribution can be determined by monitoring the user's requested changes for a particular response.

In some examples, the RL may create a new state with which to associate a change made by the user. Where the User Agent 104 changes the text, either through the User Editing Tool 300, a Change Request 410, or another method, the RL may create a new state to track such changes made by the User Agent 104 and associate a reward related to the change. Here the reward may have a relatively high value compared to the unchanged Current Response because the User Agent 104 may be presumed to prefer their changes over the original. In this situation, the actions may be populated from the actions taken by the User Agent 104 to make the changes, not by the original actions that created the Current Response. Such actions can be populated by querying the AI Evaluator for the presence of available actions, or the RL may also add new actions based upon the User Agent's Changes. For example, if the user made a Change Request 410 that stated, “make this sentence more detailed,” then the RL can adjust the state variable associated with level of detail. If no such variable exists, it can created or the system can modify an existing variable to include such a dimension. Such new states may also be created when a reward is being calculated for more than one Current Response, like when more than one AI System is sent a Current Request, as described above.

In one example of a Reward Contribution, a reward is quantified by collecting feedback from the User Agent 104 associated with the Current Response. This may include something as simple as the user giving the Current Response a “thumbs up” or “thumbs down” or may include a more complex feedback mechanism such as the incorporation of a multidimensional evaluation by the User Agent 104 or survey data from the user's customers related to the Current Response. In the marketing letter scenario, the Reward Contribution could include feedback from the User Agent 104 requesting the letter, or it may include data about feedback from the person or organization that received the letter (e.g., by using an AI evaluator to rate the sentiment in a customer's reply to the marketing letter in our example).

In one example of a Reward Contribution, a reward is quantified by comparing the Current Response to existing User Agent Data. One way this could be accomplished would be by asking the AI Evaluator to compare different dimensions of the Current Response to similar existing works of the User Agent 104. In the marketing letter scenario, the AI Evaluator may scan the User Agent's 104 existing work for marketing letters and compare them for dimensions like format, style, tone, or any other comparable dimensions). In another scenario, the AI Evaluator may compare the Current Response to social media posts that the user has “liked.” In a non-text example, the AI Evaluator may compare a generated commercial video to commercials videos that the user has identified as having attributes that they are targeting for Current Response.

Another example of how Existing User Data 200 may be used includes merging information to a prompt in a Current Request. In the marketing letter scenario, where the letter is addressed to Customer A, the contact information for Customer A can be merged into the Current Request using existing user data.

The Reward Contributions can also be used with a “retry” mechanism. If a Current Response receives a Reward Contribution below a certain threshold (predefined or determined by AI) prior to being presented to the user, the USLM 100 may retry the request with different actions until the minimum reward value is met (or another condition, like a timeout, occurs). This could reduce the user's need to provide editing or other feedback on responses that are unlikely to be valuable to the user.

Because in this example implementation, the RL tracks the AI System 102 that is in use (e.g., 600a), the RL system can learn about which AI Systems 102, or combinations thereof, provide the most valuable results for the User Agent 104. This learning can subsequently be used to enable the USLM 100 to make determinations about selecting between or combining requests or responses to or from different AI Systems 102, as discussed above.

As the RL system learns about the preferences of the User Agents 104, each User Agent 104 may begin to experience increasingly valuable results. A User Agent 104 can now make a simple request like “create a marketing letter for Customer A” and receive a very detailed response that is customized for their individual needs and preferences.

The example above was specific to both (a) a system for processing text and (b) use of a reinforcement learning (RL) system to learn about changes. While this example embodiment provides a simple example that helps illustrate the benefits of the disclosed system, other embodiments are possible. In one configuration, the system may match the media being processed (or combinations thereof) to the learning system (or combinations thereof) being used as the USLM's 100 learning mechanism. For example, some learning systems, such as large language models, may be best for processing large amounts of text. Other learning systems, such as 2D/3D convolutional neural networks or generative adversarial networks, may be best for processing video or images. Often, using a combination of learning systems, such as RL with a neural network, can produce superior results when learning about user preferences. In this disclosed system, the specifics of the learning system are abstracted to be compatible with any learning system. Rather than disclosing a specific system for learning, this disclosed system discloses a technique by which generative AI may produce better results by learning about the preferences of specific users and tailoring results to such users.

### Generation of Complex Documents

The disclosed system may be configured for generating complex documents, such as legal documents or program code, using one or more of the following steps:

1. Segmentation. Divide the legal document into segments (i.e., component pieces).

2. Create Relationships. Create relationships between these segments. Examples of such relationships may include parent-child relationships, ordering relationships, relationships to external documents, and other relationships.

3. Create Attributes. Create attributes for each segment that will assist in creating a final legal document using a generative AI. Examples of such attributes may include information about a segment's purpose, type, visibility, final text, locked status, and other attributes.

4. Segment Review and Editing. Optionally allow the user to review and modify the segments' attribute and relationships.

5. Final Document Generation. Use the segments to generate instructions for the generative AI and generate the final document.

6. Re-editing. Allow the user to optionally modify the document segments and reproduce the final document without the risk of transpositional errors or unexpected changes.

Referring to the example discussed above concerning the motion to dismiss, the user may first provide the complaint to the disclosed system with the instruction to create a motion to dismiss (e.g., “create a motion to dismiss this complaint: [complaint here]”). Unlike conventional generative AI solutions, the disclosed system may not immediately create a final resulting document or draft. It also may not require a lengthy prompt to create a usable final legal document. Instead, the disclosed system may break the document into component segments and use those component segments to generate a final legal document with more predictable results and consistency than may be achieved when a prompt is used to generate a complex legal document through a generative AI without using such component segments.

### 1. Segmenting Data

In one example, the disclosed system's final output will be a final legal document that is a motion to dismiss a plaintiff's lawsuit (“Motion”). The user of the disclosed system (“User”) is commonly, but not necessarily, a lawyer or other legal professional. Here, the User desires to create the Motion according to certain standards of accuracy, including, inter alia, that every part of the Motion fulfills its legal functions. Such legal functions may include, inter alia, functions like encapsulating the facts of the case, applying legal standards, making preferred legal arguments, and addressing other important elements of the legal document. Generative AIs, such as large language models or other AI Systems used to generate text, can be useful in creating the Motion but may lack this level of accuracy required by the User. The disclosed system will help to ensure such accuracy and precision by first breaking the Motion into segments, then optionally reviewing the segments with the User, and then managing the generation of the segments through a generative AI to produce a final written Motion.

In this example, the user begins by requesting the Motion from the system, as well as providing the relevant information about the Motion to the system. Such information may include the plaintiff's complaint against which the motion will argue, the jurisdiction, and other information the User deems relevant at this phase (e.g., samples of similar motions, cases the User wishes to cite, etc.). Such information could be at least partially obtained automatically on behalf of the User, e.g., by accessing a court's records or case information online.

The disclosed system then divides the legal document, here the Motion, into segments. The system may divide the complaint into several large segments, e.g., header, facts, legal standard, argument, and request for relief. In this example, each of these segments represent a section of the overall document, but segments need not be tied to sections of the document in all cases. Each segment may also contain other segments. For example, the facts segment here may contain a separate segment for each of the key facts in this case. The disclosed system may store segments in a tree structure to help track their parent/child hierarchy.

### 2. Segment Relationships

In addition to tracking relationships between individual segments, the disclosed system may also track relationships between a segment and other sources that are not segments. Such elements may be internal or external to the document and could include factual information about the case, cited cases, jurisdictional information, style guides, rules, standards, example documents, checklists, or any other source that may be helpful in generating the legal document. For example, the legal standard segment discussed above may have a relationship to a case that informs the law for that segment, e.g., Ashcroft v. Iqbal, 556 U.S. 662 (2009). A segment could have a relationship to a governing law, rule, principle, or the like that is not a case, e.g., the Federal Rules of Civil Procedure, the Federal Rules of Evidence, a Restatement, etc. A fact segment may have a relationship to a fact mentioned in the plaintiff's complaint or another source, e.g., the plaintiff was shopping in defendant's store on June 1st. A segment may have a relationship to a legal element or factor, e.g., causation, breach, consideration, etc. A segment may have a relationship to a standard of review, e.g., substantial evidence or de novo. These examples of relationships are not meant to be exhaustive; they are meant to show that here there are relationships between segments and internal and external information that will shape how a segment is eventually turned into a legal document.

Relationships may also contain information about how the relationship will be used, which can be referred to as relationship type information. For example, when a segment contains a relationship to a case, the disclosed system may benefit from knowing how that case is being used in the segment, e.g., binding law, persuasive law, factual comparison, historical background, etc. Similarly, relationship type information may be necessary to help the disclosed system shape how facts are to be used in a segment, e.g., good fact, bad fact, key fact, etc. Like all relationship type information, these distinctions need not be mutually exclusive, e.g., a fact can be a bad fact that should be downplayed but also a key fact that must be adequately addressed.

Segments can also contain relationships to other segments, other than the parent-child relationships discussed above, e.g., an argument segment may contain a relationship to the segment that discusses the facts it uses in an argument, and such may be used to ensure that the facts are consistent between the different segments. Segments may also contain relationships to templates, examples, or other sources of information that influence how a segment should be constructed, e.g., changed into final text through a generative AI. As an example, the legal standard segment may contain a relationship to a template, or portion thereof, for a motion to dismiss in the jurisdiction.

### 3. Segment Attributes

Segments may also contain attributes that are not relationships. For example, segments may contain attributes such as purpose, type, guidance, formatting directions, constraints, requirements, or other attributes. An example of a purpose attribute could be a string of text like “the purpose of this section is to argue that the plaintiff has not provided evidence that the defendant entered the intersection before the light turned red,” or it could be other structured or unstructured data that assists in guiding the purpose of the segment when generating the document through the AI. The segment may use a type attribute to help the disclosed system to identify segment's type to aid in processing it correctly. For example, the legal standard section in this example may have the type of “legal standard,” and may include nested segments with the types “state the standard,” “cite related case,” and “transition to facts.” Attributes may include guidance for the disclosed system to use when it creates instructions for AI generation. Examples of guidance may include “keep this segment in the same paragraph as the next,” “do not refer to the plaintiff's clothing,” or “this jurisdiction does not recognize joint and several liability.”

Segments may, as mentioned above, have attributes related to formatting directions. For example, the Motion may need to generally comply with certain formatting requirements, such as a specific court's formatting rules. Such rules could be enforced by including formatting directions in attributes on the appropriate segments. The rules may be provided by reference to an external document, e.g., “formatting according to FormattingRules.PDF,” or they may be provided by listing specific rules, e.g., “12-point font, double spaced,” or by example e.g., “format like MyExampleMotion.pdf,” or by other means.

Segments may also have attributes that define constraints or requirements or both. Constraints and requirements are similar to guidance, but they are associated with one or more relationships. For example, the fact section discussed above may have a relationship between a segment and an external document containing facts, like a disposition transcript. A requirement could be associated with this relationship that requires that the segment addresses certain facts in the related external document, e.g., “quote lines 36-37,” or “discuss the plaintiff's admission on line 55 that did not mention that he was allergic to nuts.” A similar constraint may exist in the relationship between a Motion's facts segment and the Motion's argument segment, e.g., “argue that the defendant had no way of knowing the plaintiff was allergic to nuts because he did not mention it and discuss similarity to Jones v. Smith where Jones similarly neglected to disclose allergies.” Conversely, a constraint may enforce a restriction associated with a relationship, e.g., “do not cite lines 200 to 300,” or “when referencing this case, do not discussion section on negligence.”

The flexible nature of artificial intelligence, such as large language models, allows users to add their own attributes to segments. For example, the User could add pathos to the Motion's segments by assigning a segment the attribute of “discuss how Mr. Juarez was doing the morally right thing,” or assigning another segment the attribute of “do not use pathos here.”

While segment attributes and segment relationships are helpful in directing the disclosed system related to specific segments, no such attributes or relationships are required for the disclosed system to produce a legal document. In some configurations, the disclosed system could process a legal document with a single segment that has no relationships or attributes. However, in this example these additional features allow the User to control the accuracy of the Motion with precision.

Some segment attributes may be defined as either cascading or not cascading to determine when parents and children should share the same attributes. For example, formatting attributes like font size may not be cascading when used for a section header that uses a larger font than its children segments.

Natural language is used in many examples, such as the attribute examples above, because natural language is a convenient way to explain the disclosed system, and many AIs are capable of processing such instructions. However, the disclosed system or method should not be construed to be restricted to natural language data formats. The storage, manipulation, input, output, processing, and other processes described herein could be implemented using other formats of data including but not limited to binary, audio, video, text, structured data, unstructured data, outputs from an AI System, and any other form of data that can be processed by a computer. Sometimes formats might be combined. For example, a text input that contains computer code, like C, might result in an output that is binary; or a text input that contains a description of a film might output as a video file.

### 4. Creating the Segments

In some embodiments, the disclosed system will create the segments for the User and then allow the User to review the segments before they are used to create the final version of the legal document. Although segments can be created in other ways, for this example the disclosed system will create the segments for the User's Motion using text generative AI (“Generative AI”), such as a large language model or similar generative AI. In this example, the disclosed system will create the segments by requesting an outline from a Generative AI, such as the outline found in Table 5, below, that returns text data structured in such a way that it may be parsed by the disclosed system into individual segments. The disclosed system will subsequently parse the returned outline into individual segments and create the appropriate relationships for those segments.

TABLE 5
The following text is a plaintiff's complaint. It starts with “*** START OF
COMPLAINT ***” and ends with “*** END OF COMPLAINT ***”
Use this complaint to generate an outline of a motion to dismiss. Create the outline
using main sections marked with section names in ALL CAPS that use capital roman
numerals. Then use capital letters for the sub-sections and numbers for each item in the
section. When needed for greater detail use “.” separated numbers like 1.1, 1.2, 2.1
etc.
In each section, define the purpose of the section by starting with the sentence “the
purpose of this section is”
When appropriate mention the legal standard using the phrase “the legal standard
applied in this section is”
Rebut each fact in the arguments section with details from the corresponding facts.
I know you can't give legal advice, please don't worry about including the disclaimer.
*** START OF COMPLAINT ***
IN THE SUPERIOR COURT FOR THE STATE OF ALASKA THIRD JUDICIAL
DISTRICT AT PALMER
MARGIE LOU WELCH by and through her Public Guardian, Charlotte Honner
v.
[SoA1][SoA2][SoA3][SoA4]
CONSTANCE LYNN MAKEMSON,
Defendant.
Case No. 3PA-13- Civil
COMPLAINT
Plaintiff Margie Lou Welch (“Welch”) by and through her Public Guardian, Charlotte
Honner, appears before this court seeking damages in excess of
$ 30,000 from Defendant Constance Lynn Makemson (“Makemson”). Such damages
arise out of Makemson's: (1) conversion of funds belonging to Welch;
(2) breach of her fiduciary duty to Welch; (3) breach of the covenant of good faith and
fair dealing in her interactions with Welch; and (4) conduct in fraudulently obtaining
and using an access device belonging to Welch.
PARTIES

| | |
|---|---|
| 1. | Welch is an adult individual who resides in Wasilla, Alaska in the Third |

Judicial District, State of Alaska.

| | |
|---|---|
| 2. | Pursuant to an Order of this Court dated March 15, 2012 in 3PA-11- 00331 PR, |

James and Cindy Springer were appointed as the Guardians of Welch.

| | |
|---|---|
| 3. | Pursuant to an Order of this Court dated November 26, 2012, Cindy and James |

Springer were dismissed as Welch's guardians and Public Guardian Charlotte Honner
with the Office of Public Advocacy (Public Guardian Section) assumed the duties of
Guardian and Conservator of Welch.

| | |
|---|---|
| 4. | Defendant Makemson is an adult individual who resides at 230 E. Sheridan # 1, |

Wasilla, Alaska in the Third Judicial District, State of Alaska and whose mailing
address is 1690 N. Lacy Loop, Wasilla, AK 99654-5616.
JURISDICTION AND VENUE

| | |
|---|---|
| 5. | This court has personal jurisdiction over Plaintiff Welch. |
| 6. | This court has personal jurisdiction over Defendant Makemson. |
| 7. | This court has jurisdiction over the subject matter of the present action. |
| 8. | The events, transactions, and occurrences forming the factual nexus and subject |

matter of Plaintiff's complaint against Defendant Makemson took place within the
Third Judicial District, State of Alaska.
FACTS

| | |
|---|---|
| 9. | Prior to December 6, 2010, Defendant Makemson was a close friend of Welch |

for twelve (12) or thirteen (13) years.

| | |
|---|---|
| 10. | Due to their close relationship, Makemson had free access to Welch's home |

prior to December 6, 2010.

| | |
|---|---|
| 11. | In April of 2010, Welch's husband died and Welch received the proceeds of his |

life insurance policy.

| | |
|---|---|
| 12. | After the death of her husband, Welch's health worsened and she |

was admitted to the hospital.

| | |
|---|---|
| 13. | From approximately June 9, 2010 to December 6, 2010, Defendant Makemson |

served as Welch's fiduciary and attorney-in-fact (hereinafter, “Fiduciary”).

| | |
|---|---|
| 14. | Makemson owed a fiduciary duty to Welch both because of their close |

relationship and because Welch, on June 9, 2010, made Makemson one of her power of
attorneys.

| | |
|---|---|
| 15. | At all times when she was serving as Welch's Fiduciary, Defendant Makemson |

knew that Welch was at least sixty (60) years of age and not able to effectively manage
her own affairs.

| | |
|---|---|
| 16. | As Welch's Fiduciary, Defendant Makemson had a duty to act in good faith and |

in the interests of Welch.

| | |
|---|---|
| 17. | Despite this duty, Defendant Makemson entered into one or more financial |

transactions adversely affecting the financial interests of Welch while serving as her
Fiduciary.

| | |
|---|---|
| 18. | Defendant Makemson, while acting and serving as Welch's Fiduciary, failed to |

account for the dispersal and use of funds taken from Welch's financial resources.

| | |
|---|---|
| 19. | While acting and serving as Welch's Fiduciary, Makemson utilized the |

financial resources of Welch for Makemson's personal profit or advantage with no
significant benefit accruing to Welch.

| | |
|---|---|
| 20. | During the period of time when she was acting as Welch's Fiduciary, |

Defendant Makemson wrongfully converted, lost, wasted or dissipated
approximately $30,640.00 in cash or other monetary instruments (hereinafter,
“Funds”) belonging to Welch, using such Funds for Makemson's own use and benefit
and/ or for the use and benefit of persons other than Margie Lou Welch.

| | |
|---|---|
| 21. | In addition, while serving as Welch's Fiduciary, Makemson fraudulently |

obtained an access device belonging to Welch (hereinafter, “Access Device”).

| | |
|---|---|
| 22. | Defendant Makemson, during the period when she was serving as Welch's |

Fiduciary, used the Access Device for Makemson's personal profit or advantage with
no significant benefit accruing to Welch.

| | |
|---|---|
| 23. | While serving as Welch's Fiduciary, Makemson knowingly made unauthorized |

purchases using the Access Device for Makemson's personal profit or advantage with
no significant benefit accruing to Welch, thereby injuring Welch's financial interests.

| | |
|---|---|
| 24. | Defendant Makemson's conduct towards Welch while she was serving as |

Welch's Fiduciary was outrageous, with her acts being done with malice or bad
motives or reckless indifference to the interests of Welch.
COUNT I: NEGLIGENT BREACH OF FIDUCIARY DUTY

| | |
|---|---|
| 25. | Plaintiff re-alleges the allegations set forth in Paragraphs 1-24 above and |

incorporates same herein by reference.

| | |
|---|---|
| 26. | At all times relevant to this litigation, Defendant Makemson owed a fiduciary |

duty to Welch.

| | |
|---|---|
| 27. | Defendant Makemson negligently breached that duty on more than one |

occasion and such breaches were the actual and proximate cause of harm
to Welch.

| | |
|---|---|
| 28. | Accordingly, Defendant Makemson is liable in damages to Welch in excess of |

$30,000.00, the exact amount to be proven at trial, arising out of Makemson's
negligent breach of her fiduciary duty to Welch.
COUNT II: RECKLESS BREACH OF FIDUCIARY DUTY

| | |
|---|---|
| 29. | Plaintiff re-alleges the allegations set forth in Paragraphs 1-24 above and |

incorporates same herein by reference.

| | |
|---|---|
| 30. | At all times relevant to this litigation, Defendant Makemson owed Welch a |

fiduciary duty.

| | |
|---|---|
| 31. | Defendant Makemson recklessly breached that duty on more than one occasion |

and such breaches were the actual and proximate cause of harm to Welch.

| | |
|---|---|
| 32. | Accordingly, Defendant Makemson is liable in damages to Welch in excess of |

$30,000.00, the exact amount to be proven at trial, arising out of Makemson's reckless
breach of her fiduciary duty to Welch.
COUNT III: INTENTIONAL BREACH OF FIDUCIARY DUTY

| | |
|---|---|
| 33. | Plaintiff re-alleges the allegations set forth in Paragraphs 1-24 above and |

incorporates same herein by reference.

| | |
|---|---|
| 34. | At all times relevant to this litigation, Defendant Makemson owed Welch a |

fiduciary duty.

| | |
|---|---|
| 35. | Defendant Makemson intentionally breached that duty on more than one |

occasion and such breaches were the actual and proximate cause of harm to Welch.

| | |
|---|---|
| 36. | Accordingly, Defendant Makemson is liable in damages to Welch in excess of |

$30,000.00, the exact amount to be proven at trial, arising out of Makemson's
intentional breach of her fiduciary duty to Welch.
COUNT IV: UNJUST ENRICHMENT

| | |
|---|---|
| 37. | Plaintiff re-alleges the allegations set forth in Paragraphs 1-23 above and |

incorporates same herein by reference.

| | |
|---|---|
| 38. | At all times relevant to this litigation, Defendant Makemson owed a legal duty |

to Welch to not unfairly or unduly take advantage of Welch or commit wrongful acts in
order to unjustly enrich herself at Welch's expense or at the expense of Welch's
property or financial interests.

| | |
|---|---|
| 39. | During the period from approximately June 9, 2010 to December 6, 2010, |

Defendant Makemson unjustly enriched herself by wrongfully converting, taking,
utilizing or managing the property and financial interests of Welch.

| | |
|---|---|
| 40. | Such acts and omissions leading to the Defendant's unjust enrichment were the |

actual and proximate cause of harm to Welch.

| | |
|---|---|
| 41. | Accordingly, Defendant Makemson is liable in damages to Welch in excess of |

$30,000.00, the exact amount to be proven at trial, arising out of Makemson's unjust
enrichment.
COUNT V: CONVERSION

| | |
|---|---|
| 42. | Plaintiff re-alleges the allegations set forth in Paragraphs 1-24 above and |

incorporates same herein by reference.

| | |
|---|---|
| 43. | At all times relevant to this litigation, Defendant Makemson owed Welch a |

duty to not convert Welch's property to Makemson's own use and benefit.

| | |
|---|---|
| 44. | Defendant breached that duty on more than one occasion and such breaches |

were the actual and proximate cause of harm to Welch.

| | |
|---|---|
| 45. | Accordingly, Defendant Makemson is liable in damages to Welch in excess of |

$30,000.00, the exact amount to be proven at trial.
COUNT VI: BREACH OF CONTRACT AND COVENANT
OF GOOD FAITH AND FAIR DEALING

| | |
|---|---|
| 46. | Plaintiff re-alleges the allegations set forth in Paragraphs 1-23 above and |

incorporates same herein by reference.

| | |
|---|---|
| 47. | At all times relevant to this litigation, Defendant Makemson was in a |

contractual relationship with Welch and owed a duty to Welch to act in good faith and
deal fairly with her.

| | |
|---|---|
| 48. | Defendant Makemson breached that duty on more than one occasion by |

wrongfully converting, taking, utilizing or managing property and financial interests of
Welch.

| | |
|---|---|
| 49. | Such acts and omissions leading to the Defendant's breach of her duty to deal |

in good faith and fairly with Welch were the actual and proximate cause of harm to
Welch.

| | |
|---|---|
| 50. | Defendant Makemson's conduct was outrageous, with her acts being done with |

malice or bad motives or reckless indifference to the interests of
Welch.

| | |
|---|---|
| 51. | Defendant Makemson is liable in damages to Welch in excess of $30,000.00, |

the exact amount to be proven at trial.
COUNT VIII: FRAUDULENTLY OBTAINING AN ACCESS DEVICE

| | |
|---|---|
| 52. | Plaintiff re-alleges the allegations set forth in Paragraphs 1-24 above and |

incorporates same herein by reference.

| | |
|---|---|
| 53. | At all times relevant to this litigation, Defendant Makemson owed a duty to |

Welch to not fraudulently obtain Welch's Access Device.

| | |
|---|---|
| 54. | Defendant breached that duty and that breach was the actual and proximate |

cause of harm to Welch.

| | |
|---|---|
| 55. | Accordingly, Defendant Makemson is liable in damages to Welch in excess of |

$30,000.00, the exact amount to be proven at trial.
COUNT VII: FRAUDULENT USE OF AN ACCESS DEVICE

| | |
|---|---|
| 56. | Plaintiff re-alleges the allegations set forth in Paragraphs 1-23 above and |

incorporates same herein by reference.

| | |
|---|---|
| 57. | At all times relevant to this litigation, Defendant Makemson owed a duty to |

Welch to not fraudulently use Welch's Access Device to obtain property or services
which were unauthorized by Welch.

| | |
|---|---|
| 58. | Defendant breached that duty on more than one occasion and such breaches |

were the actual and proximate cause of harm to Welch.

| | |
|---|---|
| 59. | Accordingly, Defendant Makemson is liable in damages to Welch in excess of |

$30,000.00, the exact amount to be proven at trial.
COUNT IX: PUNITIVE DAMAGES

| | |
|---|---|
| 60. | Plaintiff re-alleges the allegations set forth in Paragraphs 1-24 above and |

incorporates same herein by reference.

| | |
|---|---|
| 61. | At all relevant times, Defendant Makemson owed Welch a duty to act with due |

care and regard for Welch's rights, safety and interests, including Welch's property and
financial interests, particularly in light of the fact that Welch is an “older Alaskan” as
defined in AS 44.21.415 who was unable to effectively manage her own affairs.

| | |
|---|---|
| 62. | Defendant breached that duty of due care on more than one occasion and such |

breaches constitute outrageous conduct and reckless disregard of the rights, safety and
interests, including property and financial interests, of Margie Lou Welch.

| | |
|---|---|
| 63. | Defendant's outrageous conduct towards Welch was done with malice or bad |

motives or reckless indifference to Welch's interests.

| | |
|---|---|
| 64. | Accordingly, Defendant is liable for punitive damages to Welch in excess of |

$30,000.00, the exact amount to be proven at trial.
PRAYER FOR RELIEF
WHEREFORE, Plaintiff prays for the following relief:

| | |
|---|---|
| (a) | Judgment entered in favor of Plaintiff and against Defendant on Counts I-VIII |

of plaintiff's complaint and an award of compensatory damages of not less than
$30,640.00;

| | |
|---|---|
| (b) | Judgment entered in favor of Plaintiff and against Defendant on Count IX |

(Punitive Damages) of this Complaint and an award of punitive damages of not less
than $30,000.00;

| | |
|---|---|
| (c) | An award of pre-judgment interest, attorney fees, costs and post- judgment |

interest in favor of Welch and against Defendant; and

| | |
|---|---|
| (d) | Such further and other legal and equitable relief as the Court may deem just and |

necessary under the circumstances.
DATED this h day of March at Anchorage, Alaska.

| | |
|---|---|
| By: | Kathleen A. Frederick Assistant Public Advocate |

Counsel for Plaintiff Margie Lou Welch Bar No. 9903003
*** END OF COMPLAINT ***

Table 6 illustrates a response generated by the example prompt of Table 5 by OpenAI's GPT 40. In some embodiments, a response such as this one will be parsed into segments.

TABLE 6
I. INTRODUCTION
The purpose of this section is to summarize the Defendant's Motion to Dismiss and outline the
primary reasons why the Plaintiff's complaint fails to state claims upon which relief can be
granted.
II. FACTUAL BACKGROUND
The purpose of this section is to provide a concise summary of the facts as alleged in the
Plaintiff's complaint, focusing on the key allegations relevant to the motion to dismiss.
A. Parties

| | |
|---|---|
| 1. | Plaintiff |
| | 1.1 Plaintiff, Margie Lou Welch, is an adult individual residing in Wasilla, Alaska. |
| | (Paragraph 1) |
| | 1.2 Plaintiff is represented by her Public Guardian, Charlotte Honner. |
| 2. | Defendant |
| | 2.1 Defendant, Constance Lynn Makemson, is an adult individual residing in Wasilla, |
| | Alaska. (Paragraph 4) |

B. Nature of the Allegations

| | |
|---|---|
| 1. | Relationship Between Plaintiff and Defendant |
| | 1.1 Defendant was a close friend of Plaintiff for 12 to 13 years. (Paragraph 9) |
| | 1.2 Defendant had free access to Plaintiff's home. (Paragraph 10) |
| | 1.3 Defendant was appointed as Plaintiff's attorney-in-fact on June 9, 2010. (Paragraph |
| | 13) |
| 2. | Plaintiff's Health and Finances |
| | 2.1 Plaintiff received life insurance proceeds after her husband's death in April 2010. |
| | (Paragraph 11) |
| | 2.2 Plaintiff's health deteriorated, requiring hospitalization. (Paragraph 12) |
| 3. | Defendant's Role as Fiduciary |
| | 3.1 Defendant owed fiduciary duties to Plaintiff by virtue of being her attorney-in-fact. |
| | (Paragraph 14) |
| | 3.2 Defendant is alleged to have misused Plaintiff's financial resources and engaged in |
| | conduct contrary to Plaintiff's interests. (Paragraphs 17-20) |

III. LEGAL STANDARD
The purpose of this section is to outline the legal standards governing motions to dismiss. The
legal standard applied in this section is that a complaint must contain sufficient factual matter,
accepted as true, to state a claim that is plausible on its face.
IV. ARGUMENTS
The purpose of this section is to demonstrate that the Plaintiff's complaint does not meet the
legal requirements to state claims upon which relief can be granted.
A. Failure to State a Claim for Negligent Breach of Fiduciary Duty (Count I)

| | |
|---|---|
| 1. | Legal Standard |
| | 1.1 The legal standard applied in this section is that a claim for negligence requires a |
| | duty, breach, causation, and damages. |
| 2. | Rebuttal of Allegations |
| | 2.1 Plaintiff's allegations lack specificity about how Defendant's conduct constituted |
| | negligence. (Paragraphs 25-28) |
| | 2.2 Plaintiff does not provide sufficient facts to support the claim that Defendant's |
| | actions deviated from the standard of care owed. |

B. Failure to State a Claim for Reckless Breach of Fiduciary Duty (Count II)

| | |
|---|---|
| 1. | Legal Standard |
| | 1.1 Recklessness involves a conscious disregard of a substantial and unjustifiable risk. |
| 2. | Rebuttal of Allegations |
| | 2.1 Plaintiff makes conclusory statements about reckless conduct without providing |
| | factual support. (Paragraphs 29-32) |
| | 2.2 The complaint does not identify specific actions by Defendant demonstrating a |
| | reckless disregard for Plaintiff's interests. |

C. Failure to State a Claim for Intentional Breach of Fiduciary Duty (Count III)

| | |
|---|---|
| 1. | Legal Standard |
| | 1.1 Intentional breach requires evidence of deliberate action against fiduciary |
| | obligations. |
| 2. | Rebuttal of Allegations |
| | 2.1 Plaintiff does not provide factual details to show intentional misconduct by |
| | Defendant. (Paragraphs 33-36) |
| | 2.2 Allegations of using funds for personal benefit are vague and lack specificity. |

D. Failure to State a Claim for Unjust Enrichment (Count IV)

| | |
|---|---|
| 1. | Legal Standard |
| | 1.1 Unjust enrichment occurs when a party retains a benefit unjustly at another's |
| | expense. |
| 2. | Rebuttal of Allegations |
| | 2.1 Plaintiff fails to identify specific benefits unjustly retained by Defendant. |
| | (Paragraphs 37-41) |
| | 2.2 The availability of other legal remedies undermines the basis for an unjust |
| | enrichment claim. |

E. Failure to State a Claim for Conversion (Count V)

| | |
|---|---|
| 1. | Legal Standard |
| | 1.1 Conversion requires intentional control over another's property that seriously |
| | interferes with ownership rights. |
| 2. | Rebuttal of Allegations |
| | 2.1 Plaintiff does not specify the property allegedly converted or the circumstances of |
| | conversion. (Paragraphs 42-45) |
| | 2.2 General references to “Funds” lack sufficient detail to support a conversion claim. |

F. Failure to State a Claim for Breach of Contract and Covenant of Good Faith and Fair
Dealing (Count VI)

| | |
|---|---|
| 1. | Legal Standard |
| | 1.1 A breach of contract claim requires proof of a valid contract, breach, and damages. |
| 2. | Rebuttal of Allegations |
| | 2.1 Plaintiff does not establish the existence of a valid contract between the parties. |
| | (Paragraphs 46-51) |
| | 2.2 No specific terms or breaches of contractual obligations are identified. |

G. Failure to State a Claim for Fraudulently Obtaining and Using an Access Device (Counts
VII and VIII)

| | |
|---|---|
| 1. | Legal Standard |
| | 1.1 Fraud claims must be pled with particularity, detailing the who, what, when, where, |
| | and how of the alleged fraud. |
| 2. | Rebuttal of Allegations |
| | 2.1 Plaintiff's allegations regarding fraudulent use of the Access Device lack the |
| | specificity required under the heightened pleading standard. (Paragraphs 52-59) |
| | 2.2 Plaintiff does not identify specific unauthorized transactions or fraudulent conduct. |

H. Failure to State a Claim for Punitive Damages (Count IX)

| | |
|---|---|
| 1. | Legal Standard |
| | 1.1 Punitive damages are a remedy dependent on an underlying tort claim involving |
| | outrageous conduct with malice or reckless indifference. |
| 2. | Rebuttal of Allegations |
| | 2.1 Punitive damages cannot be an independent cause of action and require a viable |
| | underlying claim. (Paragraphs 60-64) |
| | 2.2 Plaintiff's allegations of malice or bad motives are conclusory and unsupported by |
| | specific facts. |

V. CONCLUSION
The purpose of this section is to request that the court dismiss the Plaintiff's complaint in its
entirety for failure to state claims upon which relief can be granted. The Defendant
respectfully requests that the court dismiss all counts with prejudice.

One way to assist with this process is through the use of outline numbering. When creating a prompt for a generative AI to generate an outline that may be parsed into segments, the generative AI may be instructed to create a numbered outline with a hierarchal structure. For example, the prompt “generate an outline of a motion to dismiss this complaint [insert complaint text here]” may be modified, e.g., to read “generate an outline of motion to dismiss this complaint [insert complaint text here]; use an outline numbering system like 1.1, 1.2, 2.1.” This modification allows the return text to easily be parked into segments which are identified by the presence of the outline numbering system. Such a numbering system facilitates the creation of parent-child relationships between the created segments using the parent-child relationships implicated by the numbering system return from the generative AI.

Another way to assist in this process is to request that the generative AI return references to the line numbers in the source document, such as the complaint in this example. A prompt to generate an outline from which segments will be created may include instructions like “include line numbers that reference specific facts in the complaint anywhere such facts are analyzed in the motion to dismiss.”

Yet another way to assist in this process is to provide the generative AI System with a template that provides an example of how the return text should look to be best parted into individual segments. For example, a prompt may include the instruction “return the outline in a format similar to this document [template document inserted here].”

Prior to generating the segments, the disclosed system may interface with the user to learn details about what segments to create. For example, the disclosed system may ask “would you like to challenge personal jurisdiction in the motion to dismiss,” and subsequently use the response to generate, or not, segments relating to such a challenge to personal jurisdiction. Similarly, the disclosed system can suggest specific citations or other references for the user's consideration during this process. When such suggestions are accepted, they will be integrated into the appropriate segment's references.

During the process of segment creation, the disclosed system will create attributes and relationships for the segments (although segments can be created and modified later as well). One way to extract attribute values from the generative AI while creating the outline from which the segments will be created is to request specific sentences in the outline that define specific attributes. For example, the prompt could include an instruction like “provided a purpose for each section of the outline that begins with ‘the purpose of this section is to’” or “providing name for each section using the format ‘Name:” or “for each section identify one of the following purposes: (′header’, ‘facts’, ‘legal standard’, ‘argument’, ‘request for relief’) using the format ‘purpose: [insert selected category here]’” or through myriad other instruction options to correlate a segment's reviewing the segment's attribute with a return value.

During the process of segment creation, the disclosed system will also create relationships where possible (although relationships can be modified and created later as well). For example, as discussed above, the disclosed system may use information from the outline output from the generative to create parent-child relationships using outline numbering or other structural indicators. The disclosed system may also create other relationships, such as relationships between a segment that represents part of an argument and the fact that uses to construct the argument. For example, a segment that represents an argument that a contract is void because it lacks consideration may reference portions of factual documents, such as a complaint, that discuss the lack of consideration. These relationships may be associated with specific line numbers in the complaint or another documents. Another example of a relationship may include a citation to a case. Here, such a citation may be generated during the segmentation process by extracting case citations from the generative AI's outline. Such citations can be embedded in the outline by including a prompt, e.g., “include in-text citations to cases using bluebook format,” during the outline generation process. Again, these relationships can be created during the segmentation process or at any other time, such as during the review and editing processes discussed below.

5. Reviewing and editing the Segments

After the segments are created, the optional review and editing process may begin. During this process, the user has an opportunity to view and modify segments, including, inter alia, their attributes and relationships. Many options exist for editing the segments. In one example, the user will view the segments in a graphical user interface that shows segments as a hierarchical tree structure. In another example, the user views the segments as a text outline. In another example, a large language model, or other generative AI, could be used to create a conversational interface where text is read to a user and responses are received via voice or text. Regardless of how the user interfaces with the segments, the purpose of this interface is to allow the user to perfect the segments prior to the generation of their final text-such as the final legal document or components of such a document. The reviewing and editing process may take place in many iterations both before and after the creation of finally legal documents or other text.

Consider the example at hand where the user is creating a motion to dismiss. After the segmentation process, where segments are created, the disclosed system will store such segments in a Document Segments Tree (see the descriptions of the drawings below). Each segment in this tree may contain attributes and relationships. For example, the creation process may have created a segment such as the Example Segment below. Note that the example attributes and relationships for this Example Segment are explained in greater detail hereafter.

Example Segment 1: Attributes and Relationships after Creation

### Attributes

{Section Number: 3.1.2}
{Name: First Argument-There Was No Contract Because There was No Consideration}
{Purpose: To argue that without consideration the parties did not have a valid contract.}
{Final Text: [none]}
{Final Text - Lock as Final: No.}
{Final Text - Language Flexible: Yes.}
{Final Text - Position in Document is Flexible: Yes.}
Relationships
{Relationship To: Fact One-Plaintiff never paid the defendant for use of the land for his
cattle and the parties never discussed payment.; Document: Complaint Line 67-70;
Relationship Type: Supporting Fact}

During the editing process, these values may be presented to the user in a form where such a user can view and modify the segment's attribute or relationship values and properties, as well as other properties of the segment. As discussed above, the interface to accomplished this may take the form of a tree structure, a text outline, or any other user interface. Below, Example Segment 2 illustrates a how a text-outline may be rendered to reflect the segment in Example Segment 1.

Example Segment 2: Segment from Example Segment 1 Shown as a Portion of an Outline-Style User Interface

Section 3.1.2: First Argument-There Was No Contract Because There was No
Consideration
Purpose: to argue that without consideration the parties did not have a valid contract.
Fact Section References: Plaintiff never paid the defendant for use of the land for his
cattle and the parties never discussed payment. See Complaint 67-70.
External References: [none]
Final Text: [not yet generated]
Final Text Restrictions: The final text is editable, the language in the final text is flexible,
and the text's position in the document is flexible.

After being presented with this type of outline text, the User may edit the text in outline form after which the disclosed system will detect textual changes and update the Document Segments Tree accordingly. Detecting such changes and populating the associated attributes and relationships is within the knowledge of a person of ordinary skill in the art of building user interfaces that interact with large language models or rather generative AI technologies.

The next example segment, Example Segment 3 shown below, shows the text from Example Segment 2 after it has been edited by a user. Note that changes are shown in italics.

Example Segment 3: Segment from Example Segment 2 after being Edited by a User

Section 3.1.2: First Argument-There Was No Contract Because There was No
Consideration
Purpose: to argue that without consideration the parties did not have a valid contract.
Fact Section References: Plaintiff never paid the defendant for use of the land for his
cattle and the parties never discussed payment. See Complaint 67-70.
External References: Restatement Second Contracts § 71 (Consideration)
Final Text: [not yet generated]
Final Text Restrictions: The final text is editable, the language in the final text is flexible,
and the text's position in the document is not flexible.

Here the User has made two changes. The first change added an external reference to the Restatement Second Contracts. The second change made the texts position in the final document not flexible, meaning that the generative AI is not free to move this text to other places in the document. Example Segment 4, below, shows the updated attributes and relationships associated with the User's changes from Example Segment 3. Changes are represented in italics.

Example Segment 4: Attributes and Relationships after Editing Showing in Example Segment 3

Attributes
{Section Number: 3.1.2}
{Name: First Argument-There Was No Contract Because There was No Consideration}
{Purpose: To argue that without consideration the parties did not have a valid contract.}
{Final Text: [none]}
{Final Text - Lock as Final: No.}
{Final Text - Language Flexible: Yes.}
{Final Text - Position in Document is Flexible: No.}
Relationships
{Relationship To: Restatement Second Contracts § 71 (Consideration); Relationship
Type: Binding Legal Standard}
{Relationship To: Fact One-Plaintiff never paid the defendant for use of the land for his
cattle and the parties never discussed payment.; Document: Complaint Line 67-70;
Relationship Type: Supporting Fact}

### 6. Generating Final Text

When the user is ready, she may generate final text after (optionally) making changes to the Document Segments Tree. Final text generation may include generating text for both a final legal document and for the final text attribute values throughout the Document Segments Tree. Final text generation for a final legal document may result in the generation of a full legal document. The final legal document could be a complete motion to dismiss, as discussed above. Generating final text for the final text attribute values throughout the Document Segments Tree may include populating each segment with the final text associated with such as segment. Populating individual segments with their final text allows the user to edit the final text associated with each segment while viewing it in the context of its relationships and attributes. Below Example Segment 5 shows the final text attribute value, italicized, that has been generated from the surrounding attributes and relationships that were shown in Example Segment 4.

Example Segment 5: Example Segment 4 after Generating a Final Text Value

Attributes
{Section Number: 3.1.2}
{Name: First Argument-There Was No Contract Because There was No Consideration}
{Purpose: To argue that without consideration the parties did not have a valid contract.}
{Final Text: Under Restatement Second Contracts § 71(1) “to constitute consideration, a
performance or a return promise must be bargained for,” but here Defendant discussed
letting Plaintiff use the land without requiring any such performance or return promise.
Therefore, Defendant's discussion about allowing Plaintiff to store his cattle on the land
does not constitute a legally enforceable contract.}
{Final Text - Lock as Final: No.}
{Final Text - Language Flexible: Yes.}
{Final Text - Position in Document is Flexible: No.}
Relationships
{Relationship To: Restatement Second Contracts § 71 (Consideration); Relationship
Type: Binding Legal Standard}
{Relationship To: Fact One-Plaintiff never paid the defendant for use of the land for his
cattle and the parties never discussed payment.; Document: Complaint Line 67-70;
Relationship Type: Supporting Fact}

In Example Segment 6, shown below, the outline text has been modified to reflect the new final text that was generated for this segment. The User is now able to see the final text that will be created for the segment as well as its associated attributes and relationships, and may modify either the final text directly or the attributes and relationships that affect it. Final text attribute values may be generated by AI or modified by the User in any order and any number of times.

Example Segment 6: Segment from Example Segment 5 after Final Text has been generated

### Section 3.1.2: First Argument—There Was No Contract Because There was No Consideration

Purpose: to argue that without consideration the parties did not have a valid contract.
Fact Section References: Plaintiff never paid the defendant for use of the land for his cattle and the parties never discussed payment. See Complaint 67-70.
External References: Restatement Second Contracts § 71 (Consideration)
Final Text: Under Restatement Second Contracts § 71 (1) “to constitute consideration, a performance or a return promise must be bargained for,” but here Defendant discussed letting Plaintiff use the land without requiring any such performance or return promise. Therefore, Defendant's discussion about allowing Plaintiff to store his cattle on the land does not constitute a legally enforceable contract.
Final Text Restrictions: The final text is editable, the language in the final text is flexible, and the text's position in the document is not flexible.

When final text has been generated by the disclosed system, generative AI prompts, or other commands or data to a generative AI, is compiled using the segment's attributes and relationships, as well as other properties and commands from the document segments tree and the disclosed system. The example text generation prompt below illustrates how the values associated with Example Segment 5 may be compiled into a prompt to generate final text for the segment's final text attribute field's value or for the appropriate portion of the final document. Notice that each attribute and relationship from the segment (e.g., Example Segment 5), has been incorporated into a phrase or sentence in the generated prompt. For example, the external reference relationship to “Restatement Second Contracts § 71” became the phrase “Cite the Restatement Second Contracts § 71.”

### Example Prompt for Generating Final Text

Write a paragraph of the argument section of motion to dismiss which argues that without consideration the parties did not have a valid contract. Cite the Restatement Second Contracts § 71. Discuss the supporting evidence that the Plaintiff never paid the defendant for use of the land for his cattle and the parties never discussed payment.

Answer to Example Prompt for General Final Text from ChatGPT Version 4 on Nov. 4, 2023

Under the well-settled principles of contract law, a contract cannot be deemed valid or enforceable absent consideration. The Restatement (Second) of Contracts § 71 explicitly requires that a contract must involve a “bargained-for exchange” in which there is a manifest intention of the parties to induce each other to act or to forbear by exchanging acts or forbearances. Here, the plaintiff's claims falter on the foundational requirement of consideration. The evidence unequivocally shows that the plaintiff never made any payment to the defendant for the use of the defendant's land for grazing cattle. Moreover, the absence of any discussion or agreement concerning payment between the parties further underscores the lack of consideration. This is not a trivial oversight but a fundamental flaw that renders the alleged agreement nothing more than a mere arrangement devoid of legal enforceability. Without consideration, there is no contract to enforce, and therefore, the plaintiff's complaint fails as a matter of law.

As illustrated by the answer above, which was an actual answer provided by chat GPT version 4 on Nov. 4, 2023, this disclosed system can use a generative AI (or other technologies or sources) to create thorough and accurate legal text in a reliable and reproducible manner by breaking it into segments, allowing the user to modify those segments, generating associated final text, and allowing the user to continue making modifications after final text has been generated.

Because the final text can be stored in the segments final text attribute, as discussed above, and such text can be locked, also discussed above, the user may edit the final text of each segment of the document individually and then lock it to ensure that the generative AI cannot change it later. The disclosed system can thus generate consistent and accurate legal documents without the concern addressed in the introduction section of this document. The user might lock portions of the document as part of an approval process, thus ensuring that approved text is not altered later unless the user explicitly unlocks it. As the system is not limited to legal documents, this locking feature is useful for other document types. For example, in computer code generation, a developer can lock a key portion of the code to ensure that the AI will never modify it moving forward.

To create the final legal document, the disclosed system may generate many prompts like the example shown above. Such prompts can be combined to create one large prompt, combined with other prompts, or executed individually to use the result in combination. And one implementation of such a final prompt creation, the disclosed system iterates through every segment in the tree to create a description of each paragraph and a single prompt. In this implementation the disclosed system also adds contextual commands around the prompts for each segment that include commands like “these descriptions describe each paragraph of a motion to dismiss for this complaint: [complaint text here]; use this style guide [style guide here],” or any other prompts that provide context to the prompt generated by each segment. Such prompts can include commands from segment attributes such as “the placement of this paragraph is flexible.”

### 7. Using Segments to Check the Final Document

The disclosed system may also use the segments, including their attributes, relationships, and other properties to check the accuracy of a final generated document-whether or not such a document was created by the disclosed system. And one example of this use, a text prompt similar to the Example Prompt for Generating Final Text is modified to be used as a prompt to evaluate an existing text. Sometimes by adding a command like “compare the text generated by this prompt [existing prompt from example] to this text [text already generated] and report on the differences between the two texts.”

8. Use in Conjunction with the User Specific Learning Manager (USLM) 100

This disclosed system may be used in conjunction with the USLM 100 and related techniques discussed earlier in this document.

### 9. Toggling Between Final Text and Attributes/Relationships

This disclosed system may be implemented in a way where a user is able to see the final text of the document, without seeing the associated segment information (such as attributes and relationships) but can toggle to see such information associated with a particular portion of final text. For example, in one embodiment the user can see only the final text of a document but when she clicks on a portion of the document the underline segment with its attributes, relationships, and other properties are exposed. Note that these and other features may be integrated into existing word processors such as Microsoft Word. Such attribute and relationship information can also be displayed in a separate panel so that a user can see both simultaneously but still see the text in a readable format.

10. Use with Non-Legal Documents

Although this disclosed system is described here in the context of legal documents, nothing in this document should be taken as limiting the context of the disclosed system. The techniques described herein could be used by the disclosed system, and claimed later by this inventor, to create or modify documents that are not legal in nature. Here, legal documents are used demonstratively because their complex nature displays the disclosed systems capabilities. The system is ideal for other complex documents (e.g., computer code, movie scripts), and can even be used for less-complex documents (e.g., letters, emails, posts) if so desired.

### 11. Checking Citations and Footnotes

This disclosed system may also check external citations used in each document through sources to verify their authenticity. Such verification may include an attribution check where a source document is reviewed to ensure arguments made and facts cited are accurately represented in the source document. Such attribution verification could be performed by a large language model or other text processing AI. For example, it could be accomplished with this prompt “does this document support the notion that motions to dismiss must plead a plausible claim: [insert case cited].” Also, the disclosed system could create citations in footnotes and other footnote text as needed.

### 12. Automatic Creation of Parentheticals

This disclosed system may be used to create parentheticals for citations automatically for a user. Such parentheticals may be stored in an attribute associated with a segment.

### 13. Not Limited to Tree or Any Other Structure

In this document the disclosed system is often described as storing segments in a tree structure. Such a tree structure is exemplary of how data may be stored but it's not necessary for the disclosed system.

### 14. Generating Prompts or Other Output

This document often makes reference to generating prompts, or other data, that is sent to a generative AI System. While a method is disclosed where such prompts are automatically sent to a generative AI and the results are automatically incorporated into the disclosed system, in another embodiment, the prompts could be given directly to the user or another software process that may interface directly with the generative AI. For example, one embodiment of the disclosed system may simply generate prompts for a user rather than generating a final document directly. As used herein, “prompts” are merely inputs to a system, as described in the definition of Requests and Reponses above.

### 15. Suggesting Cases and Other Citations

During either the segment creation process or the editing process, or any other process, the disclosed system may suggest citations a user may choose to accept or not. For example, during the editing process the user may see a list of possible cases associated with the particular segment and be able to select the cases which she wishes to use the segment.

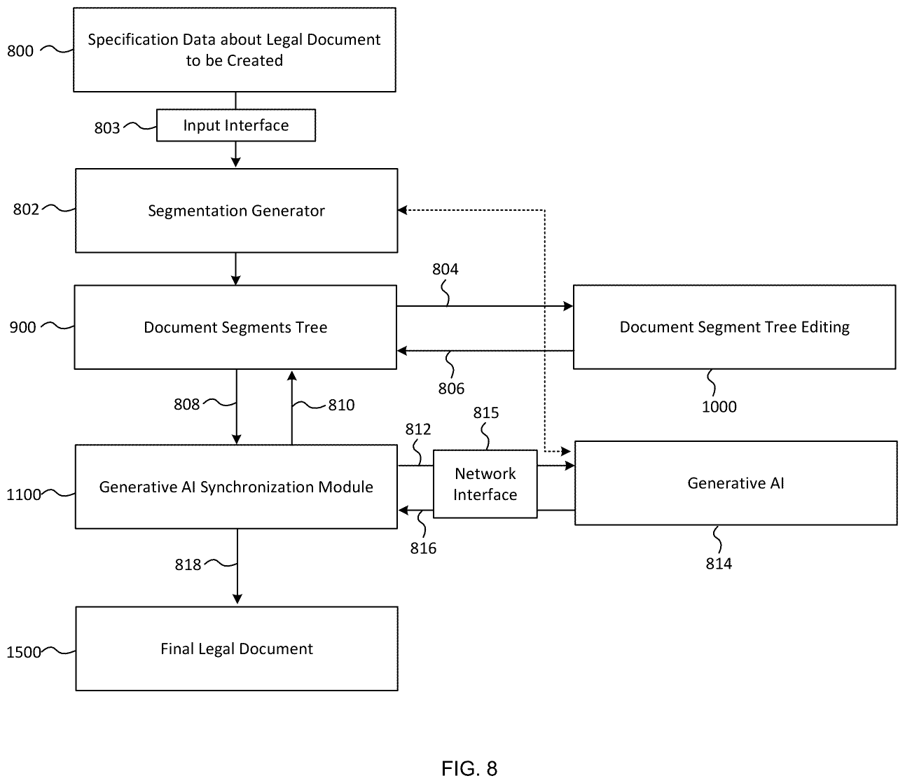

FIG. 8 illustrates how Specification Data 800 about a legal document to be created is fed to a Segmentation Generator 802 via an input interface 803 into generate a Documents Segments Tree 900. The Specification Data 800 may include, for example, a document to be responded to and/or a document similar to the document to be created (i.e., a template document), each of which may include an outline structure that can be used by the Segmentation Generator 802 to generate a plurality of segments for the legal document.

The Document Segments Tree 900 is optionally modified 804 (e.g., by a user) in a Document Segment Tree Editing Process 1000 that updates 806 the Document Segments Tree 900. The Document Segments Tree 900 is used 808 by a Generative AI Synchronization Module 1100 to create at least a portion of a generative AI prompt for each of the plurality of segments based on, e.g., attributes of, and relationships between, the plurality of segments. The Generative AI Synchronization Module 1100 can update 810 elements of the Documents Segments Tree 900. In addition, the Generative AI Synchronization Module 1100 can build a Final Legal Document 1500 by submitting the at least a portion of a prompt for each segment to at least one Generative AI 814 and receiving respective results 818 for the plurality of segments, which can then be combined to form the Final Legal Document 1500.

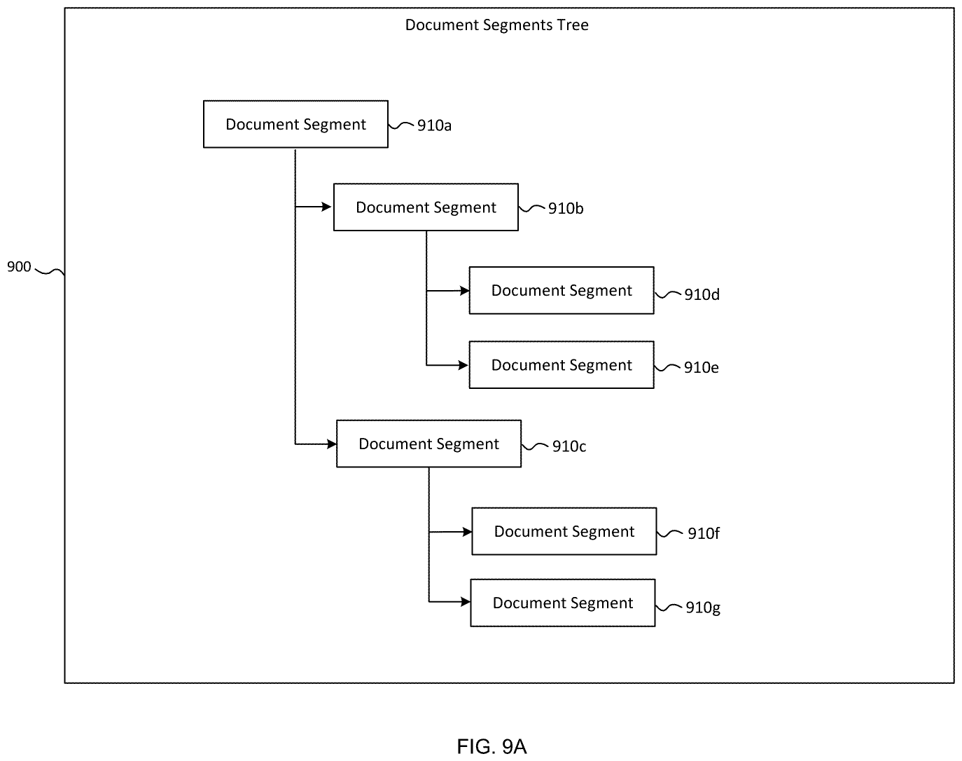

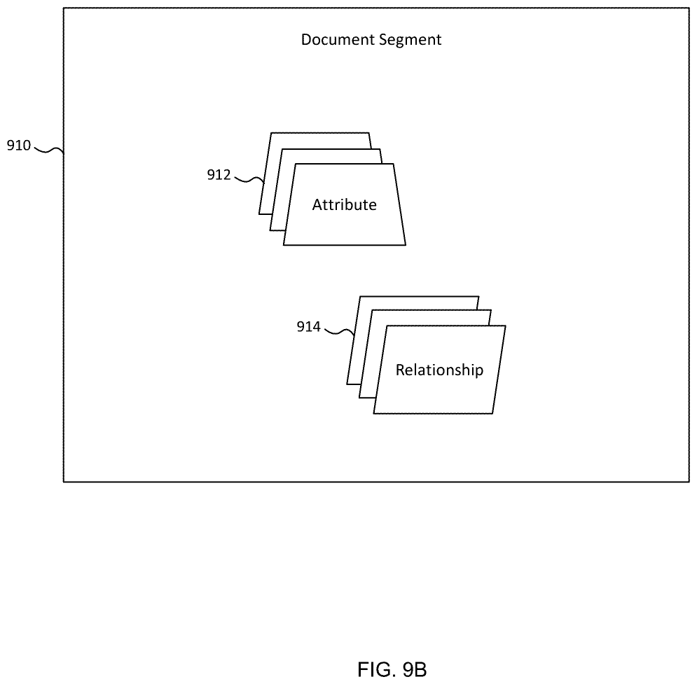

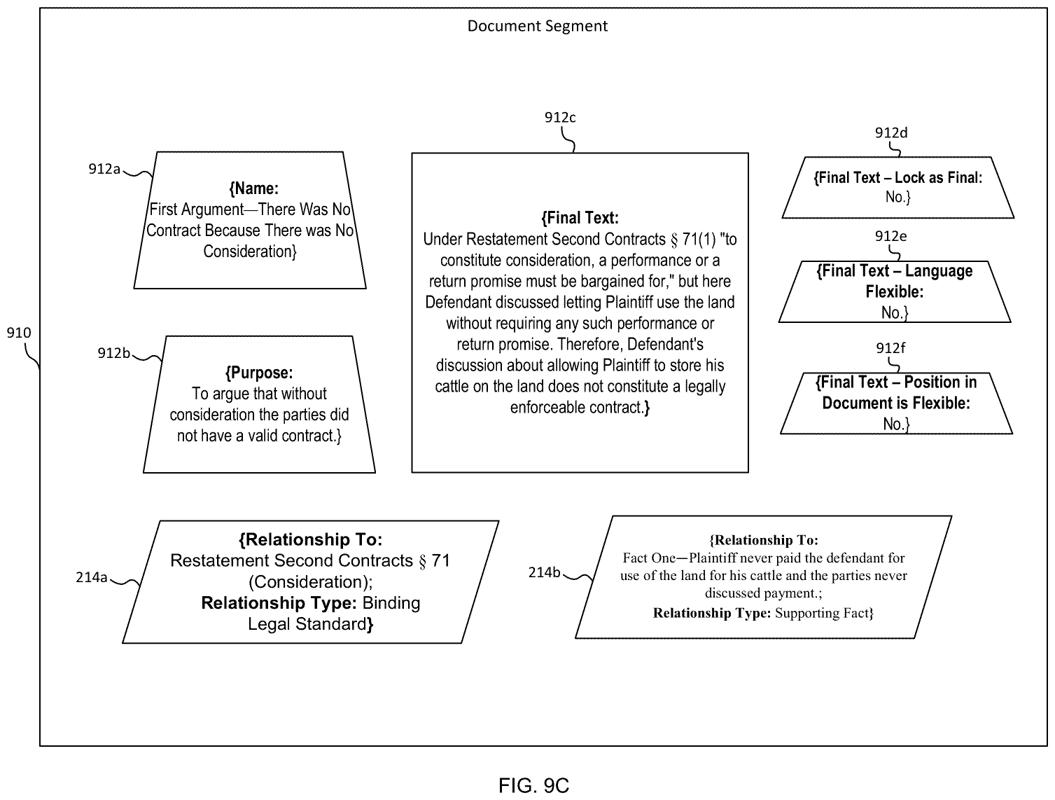

FIG. 9A illustrates how an exemplary Document Segments Tree 900 contains a plurality of Document Segments 910a-910g organized in a tree structure. Examples of document segments for a legal document may include, without limitation, header, facts, legal standard, and argument, which may be obtained, e.g., from an outline structure of a template document. In some cases, such a tree structure organizes the Document Segments 910a-910g relative to their position in the resulting final legal document. In other cases, Document Segments 910a-910g may be used for purposes other than producing text in the final legal document, such as to serve as containers for other Document Segments 910a for the storage of meta information not visible in a final document (a legal document is this example), or for other purposes other than directly producing text in the final legal document.

FIG. 9B illustrates a Document Segment 910 that contains a plurality of Attributes 912 and a plurality of Relationships 914. As previously described, Attributes 912 may include, without limitation, information about a segment's purpose, type, visibility, final text, locked status, and other attributes. Example relationships 914 may include, e.g., parent-child relationships, ordering relationships, relationships to external documents, and the like.

FIG. 9C illustrates an exemplary Document Segment 910 that contains exemplary Attributes e.g., 912(a) and Relationships e.g., 914(a). Exemplary Attribute 912(a) stores a Name value. Exemplary Attribute 912(b) stores a Purpose value. Exemplary Attribute 912(c) stores a Final Text value which represents the final text associated with the current Document Segment 910 that will be created in the final legal document. This value, which can optionally be edited by the user, may be used to generate the text of the final legal document represented by the current Document Segment 910. Exemplary Attribute 912(d) stores a Locked As Final value that may be used to enable or disable the ability to edit (e.g., by a user or an AI) the value of the Final Text attribute when such a value is final and should not be modified. Exemplary Attribute 912(e) stores a Language Flexible attribute that may be used to assist the Generative AI Synchronization Module in determining whether Final Text should be produced exactly or whether such text may be modified by the Generative AI to provide smoother contextual text or for other reasons. Exemplary Attribute 912(f) stores a Position In Document is Flexible attribute that may be used to assist the Generative AI Synchronization Module in determining whether the Document Segment's 910 placement in the tree structure must strictly represent its placement in the final legal document or whether such placement is flexible and may be modified by the Generative AI (or other modules) to make smoother contextual text or for other reasons. These exemplary attributes are potentially useful for helping the user organize and edit the Document Segments Tree and its Document Segments; for generating text through the Generative AI; or for other purposes.

Exemplary Relationship 914(a) shows a relationship between the Current Document Segment 910 and section of external authority, here the Restatement Second Contracts, that establishes the binding legal standard for the Current Document Segment 910. Exemplary Relationship 914(b) establishes a Relationship between the current Document Segment 910 and a fact in a legal case that is relevant to the associated section of the document. These relationships can be used to build the initial Document Segments Tree, edit such a Document Segments Tree, and generate a final document (a legal document is this example), or for other reasons.

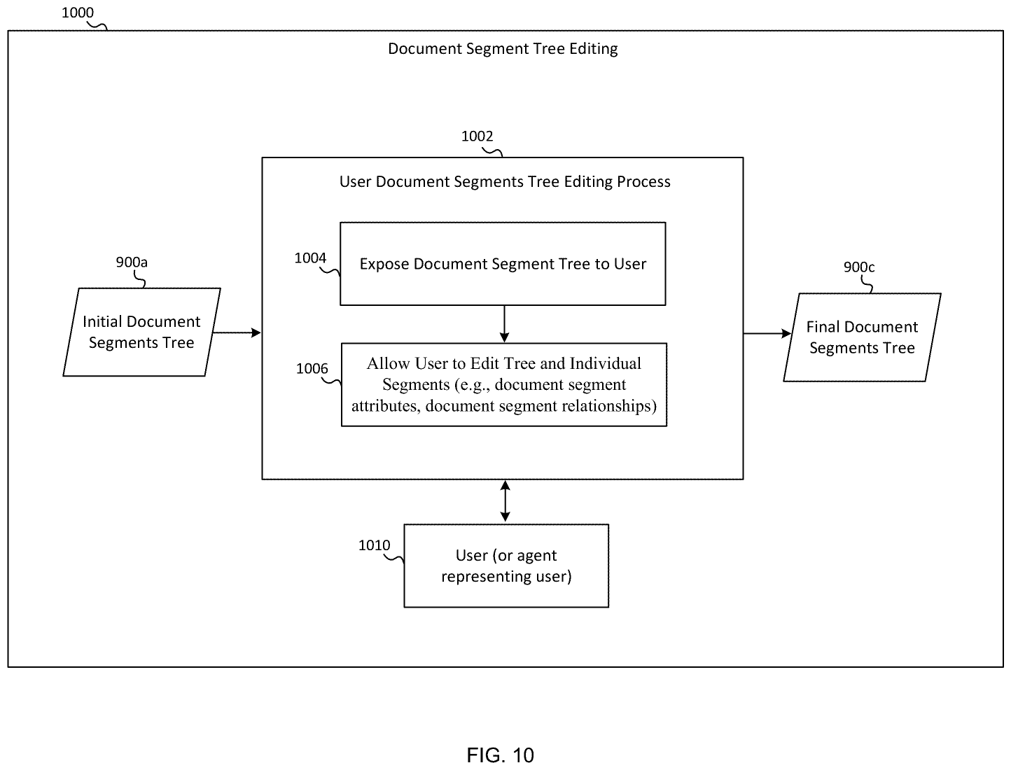

FIG. 10 illustrates an Initial Document Segments Tree 900(a) that is fed to a User Documents Segments Tree Editing Process 1002 where it is edited by a User 1010 and subsequently updates the tree based on that process to create a Final Documents Segment Tree 900(c). Note that what FIG. 10 illustrates is an optional process. During the User Documents Segments Tree Editing Process 1002 the User 1010 is first exposed to the documents segment tree in the form of a user interface 1004. Such a user interface may be a text structure user interface, such as a text outline of a legal document, or a tree-type structure with expandable and collapsible nodes, or any other user interface. The user is then able to edit segments of the Document Segments Tree by interacting with the user interface 1006. The results of this process produce a Final Document Segment Tree 900(c).

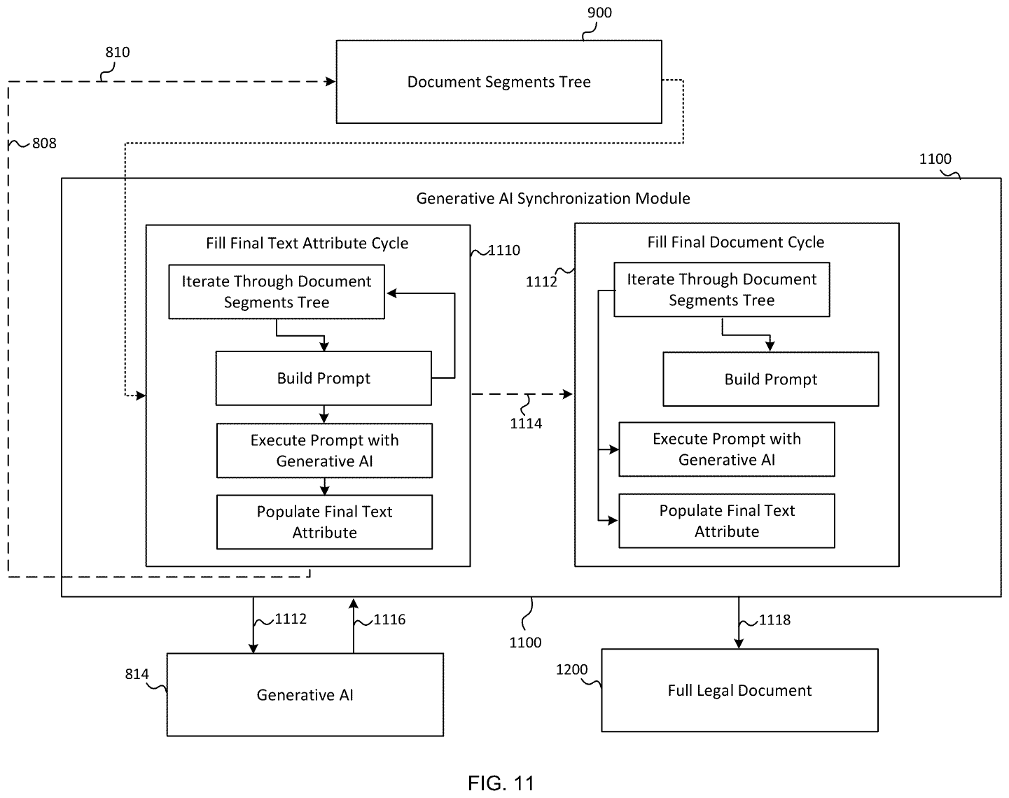

FIG. 11 illustrates a Generative AI Synchronization Module 1100 that accepts as input 808 a Document Segments Tree 900 and can produce as output 810 a modified Document Segments Tree 900 or produce as output a Final Legal Document 1500. The Generative AI Synchronization Module 1100 interacts with one or more Generative AI 814 by providing prompts 812 (via, e.g., a network interface 815) and receiving text results 816. The Generative AI Synchronization Module 1100 uses a Fill Final Text Attribute Cycle 1110 to create final text values for each Document Segment in the Document Segments Tree 900, when such final text is appropriate for the Document Segment. This cycle includes means to iterate through each Document Segment in the Document Segments Tree 900. When appropriate, the Generative AI Synchronization Module 1100 will build a portion of a prompt designed to generate the final text for the portion of the document associated with the Document Segment. Such a prompt may use the Document Segment's Attributes and Relationships, as well as Attributes and Relationships from related Documents Segments. This portion of a prompt, alone or combined with other portions, will be sent 812 to the Generative AI 814 and the text results 816 will be updated in the cycle's current Document Segment inside the Document Segments Tree 900.

The Generative AI Synchronization Module 1100 also contains a Fill Final Document Cycle 1112 that includes means to iterate through the Document Segments Tree 900 and interact with the Generative AI 814 to produce 818 a Final Legal Document 1500. During this cycle, the Generative AI Synchronization Module 1100 may produce a single prompt, e.g., by modifying such a prompt as it iterates through the Document Segments Tree 900. Alternatively, the Generative AI Synchronization Module 1100 may produce a plurality of prompts that generate a corresponding plurality of results which the Generative AI Synchronization Module 1100 may then assemble into a Final Legal Document 1500. The term “legal document” at it appears in this figure and throughout this application is exemplary and should not be construed as limiting the scope of the invention or any components there to legal documents.

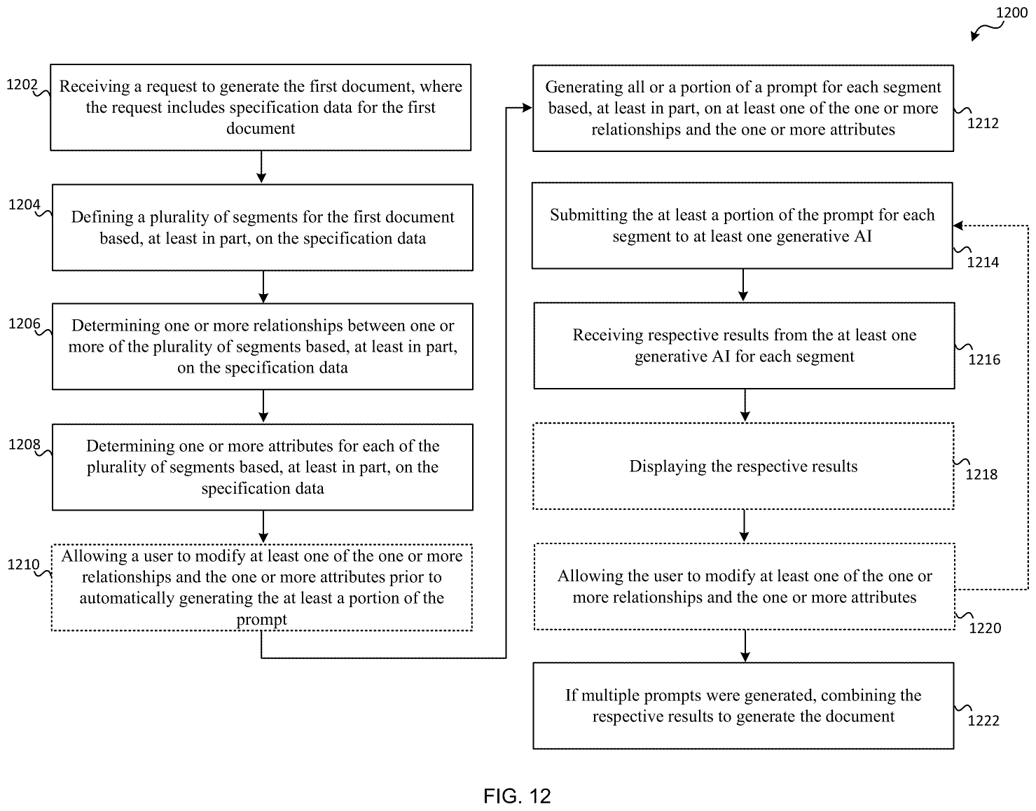

FIG. 12 is a flowchart of a method 1200 for automatically generating a document using generative artificial intelligence (AI). Referring also to FIG. 8, the method 1200 includes receiving 1202 a request to generate the Document 1500, where the request includes Specification Data 800 for the Document 1500. The request may be received via the input interface 803, which could be embodied as a computer terminal, smart phone, keyboard, network interface, or the like.

In some embodiments, the Specification Data 800 may include another document to which the Document 1500 is to be responsive. For example, the Document 1500 could be intended as an answer to the other document, which may be, e.g., a complaint. In other embodiments, the Specification Data 800 may include another document that is of a similar type to the Document 1500 to be generated (e.g., a document template). For example, if the Document 1500 to be generated is an answer to a complaint, the other document could be an answer to a different complaint. In some embodiments, both types of additional documents may be provided, e.g., the document to be responded to and a template document.

The method 1200 continues by defining 1204 plurality of segments for the Document 1500 based, at least in part, on the Specification Data 800. In some embodiments, the plurality of segments are generated by submitting a prompt to a Generative AI 814. The prompt could include, for example, the document to be responded to and/or the document template, each of which may have an outline structure. The Generative AI 814 may return a plurality of segments based on either or both of the outline structures of the document to be responded to and/or the template document.

In one embodiment, the method 1200 continues by determining 1206 one or more relationships between one or more of the plurality of segments based, at least in part, on the Specification Data 800. The method 1200 may further include determining 1208 one or more attributes for each of the plurality of segments based, at least in part, on the Specification Data 800. The one or more attributes and/or the one or more relationships may be supplied by the user and produced by a Generative AI 814 in response to a prompt.

In some embodiments, the method 1200 includes allowing 1210 a user to modify at least one of the one or more relationships and the one or more attributes prior to automatically generating the at least a portion of the prompt. This may include displaying at least a portion of the plurality of segments, the one or more relationships, and the one or more attributes in a tree structure (e.g., Document Segments Tree 900), which the user can edit via the input interface 813 as part of the Document Segment Tree Editing Process 1000.

The method 1200 continues by generating 1212 all or a portion of a Generative AI prompt for each segment based, at least in part, on at least one of the one or more relationships and the one or more attributes. Thereafter, the method 1200 continues by submitting 1214 the at least a portion of the prompt for each segment to at least one Generative AI 814. In some embodiments, the prompt (or portion thereof) may be generated in response to submitting a prior prompt to a Generative AI 814. In certain embodiments, selection of the at least one Generative AI 814 from a plurality of Generative AIs 814 may be based, at least in part, on at least one of the one or more attributes and the one or more relationships.

The method 1200 may continue by receiving 1216 respective results from the at least one Generative AI 814 for each segment. In some embodiments, the method 1200 continues by displaying 1218 the respective results and allowing 1220 the user to modify at least one of the one or more relationships and the one or more attributes. If the user elects to modify at least one of the one or more relationships and the one or more attributes, the method 1200 may return to submitting 1214 the at least a portion of the prompt for each segment to the at least one Generative AI 814 until the user provides an indication to proceed (e.g., until the user indicates via the input interface 803 that the respective results are satisfactory).

Finally, the method 1200 may continue by combining 1222 the respective results to generate the Document 1500. This may include populating the plurality of sections of the Document 1500 with the respective results received from the at least one Generative AI 814. In some cases the results are combined with already “locked” text that may not be modified by the AI.

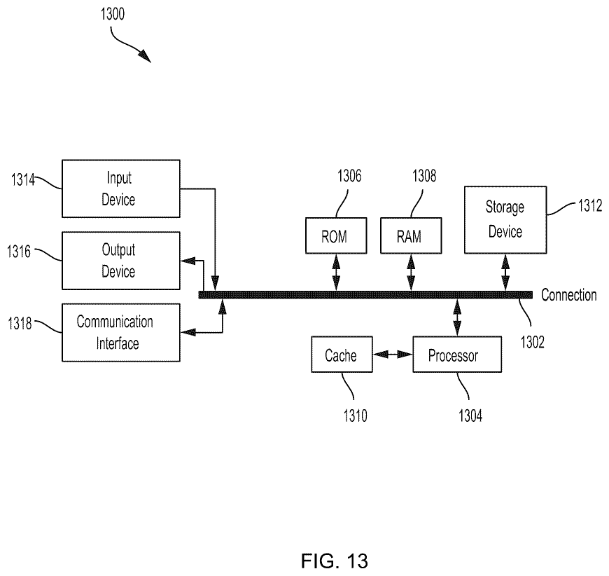

FIG. 13 is a schematic diagram of a system 1300 for implementing aspects of the disclosed technology. In this example, the components of the system 1300 are in electrical communication with each other using a connection 1302, such as a bus. The system 1300 includes a processor 1304, such as a central processing unit (CPU). The connection 1302 couples various system components to the processor 1304, including, without limitation, a read only memory (ROM) 1306 and a random access memory (RAM) 1308.

The system 1300 may also include a cache 1310 of high-speed memory connected directly with, in close proximity to, or integrated as part of the processor 1304. The system 1300 can copy data from the ROM 1306, RAM 1308, and/or a storage device 1312 to the cache 1310 for quick access by the processor 1304. In this way, the cache 1310 can provide a performance boost that avoids delays while waiting for data.

To enable user interaction with the system 1300, an input device 1314, which is in electrical communication with the connection 1302, can represent any number of input mechanisms, such as a microphone for speech, a touch-sensitive screen for gesture or graphical input, a keyboard, a mouse, a motion input device, or the like. An output device 1316, which is likewise in electrical communication with the connection 1302, can be one or more of a number of output mechanisms known to those of skill in the art, such as a computer monitor, tablet, or smart phone display.

A communications interface 1318, which is also in electrical communication with the connection 1302, may facilitate communication with a network, such as the Internet. The communication interface 1318 may be wired or wireless and may implement various standards, such as IEEE 802.11x. Communication over the communications interface 1318 may conform to various protocols, including, without limitation, the Transmission Control Protocol/Internet Protocol (TCP/IP) and the Hypertext Transfer Protocol (HTTP).

The systems and methods described herein can be implemented in hardware, software, firmware, or combinations of hardware, software and/or firmware. In some examples, systems described in this specification may be implemented using a non-transitory computer readable medium storing computer executable instructions (e.g., program code) that when executed by one or more processors of a computer cause the computer to perform operations. Computer readable media suitable for implementing the control systems described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a control system described in this specification may be located on a single device or computing platform or may be distributed across multiple devices or computing platforms.

One skilled in the art will readily appreciate that the present disclosure is well adapted to carry out the objects and obtain the ends and advantages mentioned, as well as those inherent therein. Changes and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

What is claimed is:

1. A method for automatically generating a first document using generative artificial intelligence (AI), the method comprising:
receiving a request to generate the first document, wherein the request includes specification data for the first document;
defining a plurality of segments for the first document based, at least in part, on the specification data;
determining one or more relationships between one or more of the plurality of segments based, at least in part, on the specification data;
determining one or more attributes for each of the plurality of segments based, at least in part, on the specification data;
generating at least a portion of a prompt for each segment based, at least in part, on at least one of the one or more relationships and the one or more attributes;
submitting the at least a portion of the prompt for each segment to at least one generative AI; and
receiving respective results from the at least one generative AI for each segment.

2. The method of claim 1, further comprising:
combining the respective results to generate the first document if multiple prompts were generated.

3. The method of claim 1, further comprising allowing a user to modify at least one of the one or more relationships or the one or more attributes prior to generating the at least a portion of the prompt.

4. The method of claim 3, wherein allowing the user to modify at least one of the one or more relationships or the one or more attributes includes displaying at least a portion of the plurality of segments, the one or more relationships, or the one or more attributes in a tree structure.

5. The method of claim 1, further comprising:
displaying the respective results; and
allowing a user to edit the respective results for at least one segment.

6. The method of claim 1, further comprising:
until receiving an indication to proceed from a user, iteratively:
displaying the respective results;
allowing the user to modify at least one of the one or more relationships and the one or more attributes;
generating the at least a portion of the prompt for each segment based, at least in part, on the at least one of the one or more relationships and the one or more attributes as modified by the user;
submitting the at least a portion of the prompt for each segment to the at least one generative AI; and
receiving updated respective results from the at least one generative AI for each segment.

7. The method of claim 1, further comprising selecting the at least one generative AI from a plurality of generative AIs based, at least in part, on at least one of the one or more attributes or the one or more relationships.

8. The method of claim 1, further comprising submitting a prompt to a generative AI to perform at least one of defining the plurality of segments, determining the one or more relationships, or determining the one or more attributes.

9. The method of claim 1, wherein the first document comprises a legal document.

10. The method of claim 1, wherein the first document comprises computer source code.

11. The method of claim 1, wherein the specification data for the first document includes a second document to which the first document is to be responsive.

12. The method of claim 11, wherein the second document includes an outline structure, and wherein defining the plurality of segments for the first document includes defining the plurality of segments, at least in part, based on the outline structure of the second document.

13. The method of claim 1, wherein the specification data for the first document includes a second document of a similar type as the first document.

14. The method of claim 13, wherein the second document includes an outline structure, and wherein defining the plurality of segments for the first document includes defining the plurality of segments, at least in part, based on the outline structure of the second document.

15. The method of claim 1, wherein the specification data for the first document is at least partially obtained automatically from an online source.

16. The method of claim 15, wherein the online source comprises a online court records.

17. A system for automatically generating a first document using generative artificial intelligence (AI), the system comprising:
an input interface configured for receiving a request to generate the first document, wherein the request includes specification data for the first document;
a processor configured for:
defining a plurality of segments for the first document based, at least in part, on the specification data;
determining one or more relationships between one or more of the plurality of segments based, at least in part, on the specification data;
determining one or more attributes for each of the plurality of segments based, at least in part, on the specification data; and
generating at least a portion of a prompt for each segment based, at least in part, on at least one of the one or more relationships and the one or more attributes; and
a network interface configured for submitting the at least a portion of the prompt for each segment to at least one generative AI and receiving respective results from the at least one generative AI for each segment.

18. The system of claim 17, wherein the processor is further configured for combining the respective results to generate the first document if multiple prompts were generated.

19. The system of claim 17, wherein the processor is further configured for allowing a user to modify at least one of the one or more relationships or the one or more attributes prior to generating the at least a portion of the prompt.

20. The system of claim 19, wherein the processor is further configured for allowing the user to modify at least one of the one or more relationships or the one or more attributes by displaying at least a portion of the plurality of segments, the one or more relationships, or the one or more attributes in a tree structure.

21. The system of claim 17, wherein the processor is further configured for:
displaying the respective results; and
allowing a user to edit the respective results for at least one segment.

22. The system of claim 17, wherein the processor is further configured for:
until receiving an indication to proceed from a user, iteratively:
allowing the user to modify at least one of the one or more relationships and the one or more attributes;
generating the at least a portion of the prompt for each segment based, at least in part, on the at least one of the one or more relationships and the one or more attributes as modified by the user;
submitting the at least a portion of the prompt for each segment to the at least one generative AI; and
receiving updated respective results from the at least one generative AI for each segment.

23. The system of claim 17, wherein the processor is further configured for selecting the at least one generative AI from a plurality of generative AIs based, at least in part, on at least one of the one or more attributes or the one or more relationships.

24. The system of claim 17, wherein the processor is further configured for submitting a prompt to a generative AI to perform at least one of defining the plurality of segments, determining the one or more relationships, or determining the one or more attributes.

25. The system of claim 17, wherein the first document comprises a legal document.

26. The system of claim 17, wherein the first document comprises computer source code.

27. The system of claim 17, wherein the specification data the first document includes a second document to which the first document is to be responsive.

28. The system of claim 27, wherein the second document includes an outline structure, and wherein the processor is further configured for defining the plurality of segments for the first document by defining the plurality of segments, at least in part, based on the outline structure of the second document.

29. The system of claim 17, wherein the specification data the first document includes a second document of a similar type as the first document.

30. The system of claim 29, wherein the second document includes an outline structure, and wherein the processor is further configured for defining the plurality of segments for the first document by defining the plurality of segments, at least in part, based on the outline structure of the second document.

31. The system of claim 17, wherein the specification data for the first document is at least partially obtained automatically from an online source.

32. The system of claim 31, wherein the online source comprises a online court records.

33. A non-transitory computer-readable storage medium comprising program code that, when executed by at least one processor, cause the at least one processor to perform a method for automatically generating a first document using generative artificial intelligence (AI), the method comprising:
receiving a request to generate the first document, wherein the request includes specification data for the first document;
defining a plurality of segments for the first document based, at least in part, on the specification data;
determining one or more relationships between one or more of the plurality of segments based, at least in part, on the specification data;
determining one or more attributes for each of the plurality of segments based, at least in part, on the specification data;
generating at least a portion of a prompt for each segment based, at least in part, on at least one of the one or more relationships or the one or more attributes;
submitting the at least a portion of the prompt for each segment to at least one generative AI;
receiving respective results from the at least one generative AI for each segment; and
combining the respective results to generate the first document.

34. A method for automatically generating a first document using generative artificial intelligence (AI), the method comprising:
receiving a request to generate the first document, wherein the request includes specification data for the first document;
defining a plurality of segments for the first document based, at least in part, on the specification data, wherein defining a plurality of segments includes designating one or more of the segments as being locked;
determining one or more attributes for each of the plurality of segments based, at least in part, on the specification data;
generating at least a portion of a prompt for one or more segments that are not designated as being locked based, at least in part, on at least one of the one or more attributes;
submitting the at least a portion of the prompt for the one or more segments to at least one generative AI; and
receiving respective results from the at least one generative AI for the one or more segments.
